(19) United States
(12) Patent Application Publication
(10) Pub. No.: US 2010/0235296 A1
(43) Pub. Date: Sep. 16, 2010

(54) FLOW COMPARISON PROCESSING METHOD AND APPARATUS

(75) Inventor: Katsuhisa NAKAZATO, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki (JP)

(21) Appl. No.: 12/692,590

(22) Filed: Jan. 23, 2010

(30) Foreign Application Priority Data
Mar. 10, 2009 (JP) 2009-056190

(51) Int. Cl. G06Q 10/00

(52) U.S. Cl. 705/348

(57) ABSTRACT

An apparatus includes an extracting unit which specifies a most frequent occurrence position section regarding an event category of an event in a first flow data and associates a most frequent occurrence group including the most frequent occurrence position section and the event category, and a display unit which displays a node included in second flow data and an occurrence position section of the node and displays the event category and the most frequent occurrence group.

### CROSS-REFERENCE TO RELATED APPLICATIONS

This application is based upon and claims the benefit of priority of the prior Japanese Patent Application No. 2009-56190, filed on Mar. 10, 2009, the entire contents of which are incorporated herein by reference.

### FIELD

The present technique relates to a technique for comparing flowcharts.

### BACKGROUND

One of the main purposes of visualization of a business process based on a flowchart is that the visualization helps understand current problems in the business process, leading to improved business efficiency.

A technique for visualizing a business process has been available in which a series of business events which are relevant to each other is extracted from process records accumulated in a database of a business system and is combined into a business process which is visualized as a flowchart (for example, Japanese Laid-open Patent Publication No. 2008-27072).

### SUMMARY

According to an aspect of the invention, an apparatus includes an extracting unit which specifies a most frequent occurrence position section regarding an event category of an event in a first flow data and associates a most frequent occurrence group including the most frequent occurrence position section and the event category, and a display unit which displays a node included in second flow data and occurrence position section of the node and displays the event category and the most frequent occurrence group.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram of a flow comparison processing apparatus according to the present embodiment.

FIGS. 2A to 2F are diagrams illustrating a process flow in the present embodiment.

FIG. 3 is a diagram illustrating an example of tables a, b, and c which are stored in databases A and B.

FIG. 4 is a diagram illustrating data of event instances.

FIG. 5 is a diagram illustrating an example of a process instance group.

FIG. 6 is a diagram explaining the calculation of occurrence positions of an event.

FIG. 7 is a diagram illustrating an example of an occurrence position management table.

FIG. 8 is a diagram illustrating an example of records of a specific event type which are extracted from the occurrence position management table.

FIG. 9 is a diagram illustrating an example of a table in which the frequencies of occurrence in individual sections are registered.

FIG. 10 is a diagram illustrating an example of a table in which data of most frequent occurrence sections for individual event types is registered.

FIG. 11 is a diagram illustrating an example of grouping of the event types.

FIG. 12 is a schematic diagram explaining the calculation of shortest distances.

FIG. 13 is a diagram illustrating an example of a node transition matrix.

FIG. 14 is a diagram illustrating an example of a table for distances from a start point and distances from an end point.

FIG. 15 is a diagram illustrating an example of grouping of nodes.

FIG. 16 is a diagram illustrating an example of a business performance flow.

FIG. 17 is a diagram illustrating an example of a design flow.

FIG. 18 is a diagram illustrating an example of grouping of events.

FIG. 19 is a diagram illustrating an example of process results of a distance calculation process.

FIG. 20 is a diagram illustrating an example of correspondences between nodes and events.

FIG. 21 is a diagram illustrating an example of additionally displaying results of grouping.

FIG. 22 is a diagram illustrating an example of first presenting results of grouping.

FIG. 23 is a diagram illustrating a second example of the business performance flow.

FIG. 24 is a diagram illustrating a second example of the design flow.

FIG. 25 is a diagram illustrating an example of grouping for the second example of the business performance flow.

FIG. 26 is a diagram illustrating an example of process results of a distance calculation process performed on the second example of the design flow.

FIG. 27 is a diagram illustrating an example of grouping for the second example of the design flow.

FIG. 28 is a diagram illustrating comparison between the grouping of nodes and the grouping of events.

FIG. 29 is a diagram illustrating an example of results of performing character string matching on a group-by-group basis.

FIG. 30 is a diagram illustrating the correspondence relationship between nodes and events using the comparison between flowcharts.

FIG. 31 is a diagram illustrating an example of results of performing character string matching without using grouping.

FIG. 32 is a diagram illustrating an example of a case where results of performing character string matching without using grouping are represented using the comparison between flowcharts.

FIG. 33 is a functional block diagram of a computer.

### DESCRIPTION OF EMBODIMENTS

In order to understand current problems in a business process, comparison between a flowchart of a current business process and a flowchart illustrating the true version of the business process may facilitate a more effective analysis than the use of a flowchart of a current business process alone.

However, since the flow of the true version is created by a designer or analyst at the system design or review stage or at any other stage and is different in its origin from the flow of the current business process, even the same business system often has different flowchart representations. The term “different flowchart representations”, as used herein, refers to (a) different node names in the flowcharts and (b) different granularities of nodes, resulting in different numbers or structures.

Further, problems involved in design flows, such as insufficient consideration at the design stage, insufficient description in the specification at the design stage, and insufficient reflection in the specification during the addition to or change in the specification, may result in a design flow which is not well suited for actual use. Similarly, business performance flows may have a problem in that incorrect business performance flows are generated due to mismatch of time caused by operating environments, incomplete log records, or the like.

These problems cause difficulties in matching based on node names or matching based on topology, and may also cause difficulties in extraction of problems in a business process based on the comparison between both flowcharts, which is the original aim.

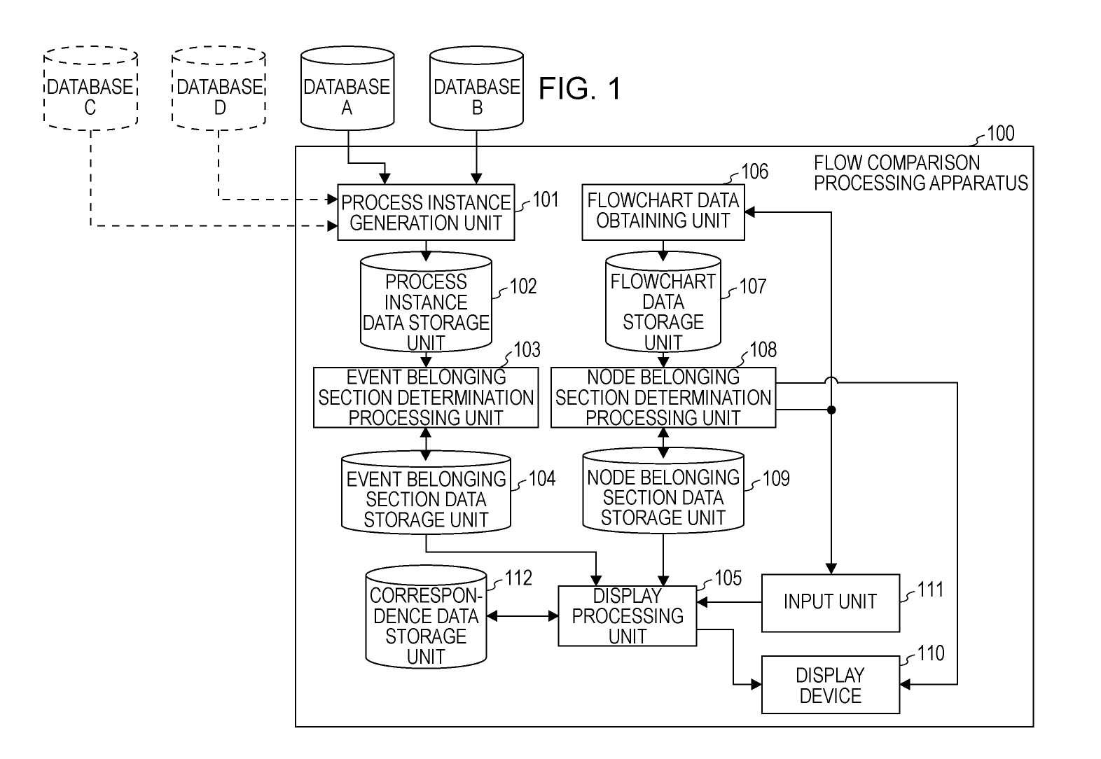

An overview of a system according to an embodiment of the present technique will now be described with reference to FIG. 1. In the embodiment, two flowcharts are compared by way of example. In this case, it is assumed that at least one flowchart is a flowchart which is understood using a plurality of process instances (that is, specific examples of a business performance flow). The other flowchart may be a flowchart which is understood using a plurality of process instances obtained from different pieces of information (such as, for example, databases), or may be any other flowchart such as an engineering drawing.

A flow comparison processing apparatus 100 includes a process instance generation unit 101 that generates process instances from a database (or a replica thereof) in a business system, such as, for example, databases A and B; a process instance data storage unit 102 that stores data of the process instances generated by the process instance generation unit 101; an event belonging section determination processing unit 103 that performs a process of specifying a section in the business performance flow where each event category (also referred to as an event type or event class) occurs by using the data stored in the process instance data storage unit 102; an event belonging section data storage unit 104 that stores processing results obtained by the event belonging section determination processing unit 103; a flowchart data obtaining unit 106 that obtains flowchart data via, for example, a network or from a specified storage device or the like; a flowchart data storage unit 107 that stores the flowchart data obtained by the flowchart data obtaining unit 106; a node belonging section determination processing unit 108 that performs a process of specifying a section in a flowchart where each node of the flowchart occurs by using the data stored in the flowchart data storage unit 107; a node belonging section data storage unit 109 that stores processing results obtained by the node belonging section determination processing unit 108; a display processing unit 105 that performs a process such as generating display data or the like using the data stored in the event belonging section data storage unit 104 and the data stored in the node belonging section data storage unit 109; a display device 110 that displays the display data generated by the display processing unit 105; an input unit 111 that is coordinated with the flowchart data obtaining unit 106, the display processing unit 105, and the node belonging section determination processing unit 108 to transmit an input given by a user to individual portions; and a correspondence data storage unit 112 that stores data which is specified based on processing results obtained by the display processing unit 105 and the data input through the input unit 111, and which indicates the correspondence relationship between the event categories included in the business performance flow and the nodes included in the flowchart.

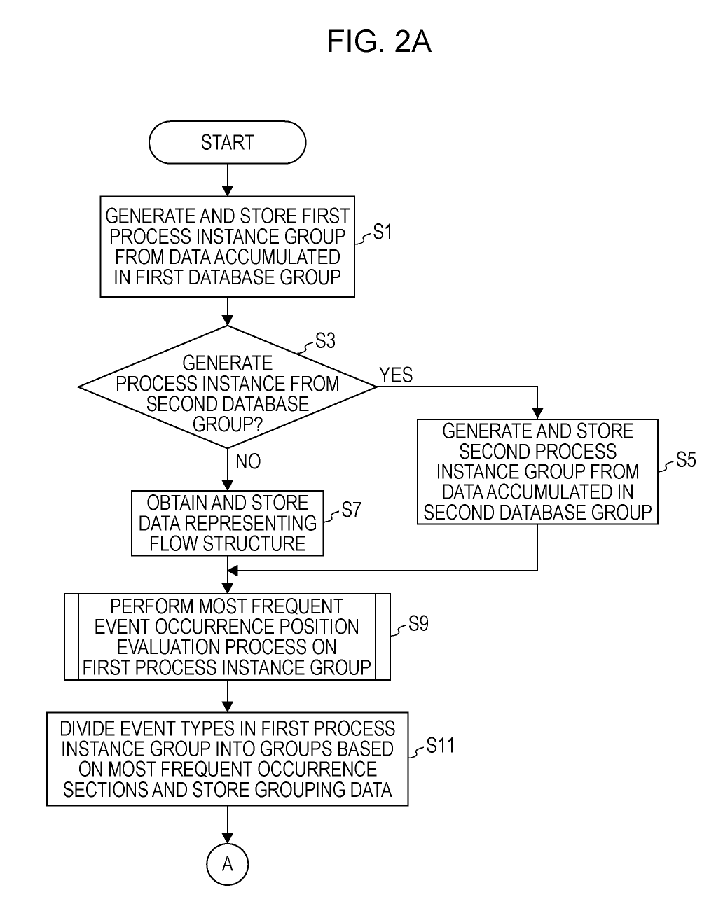

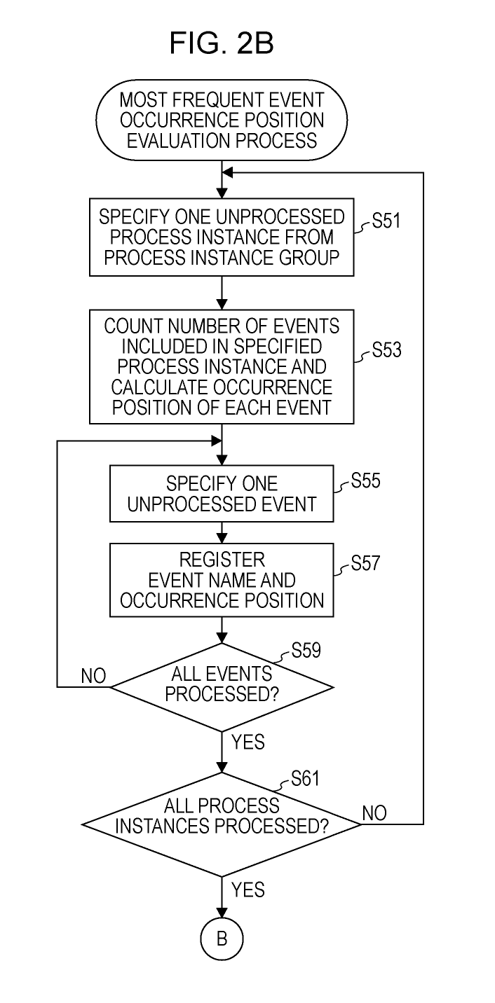

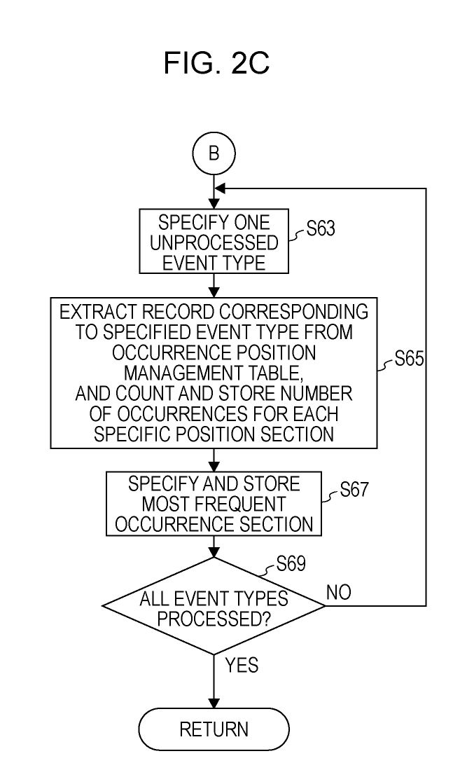

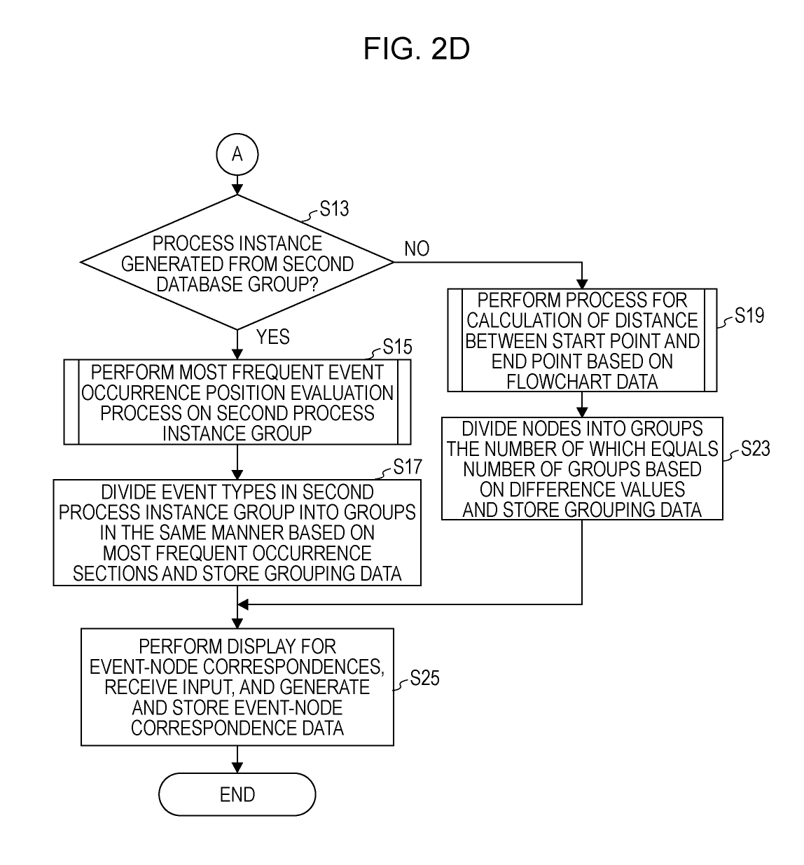

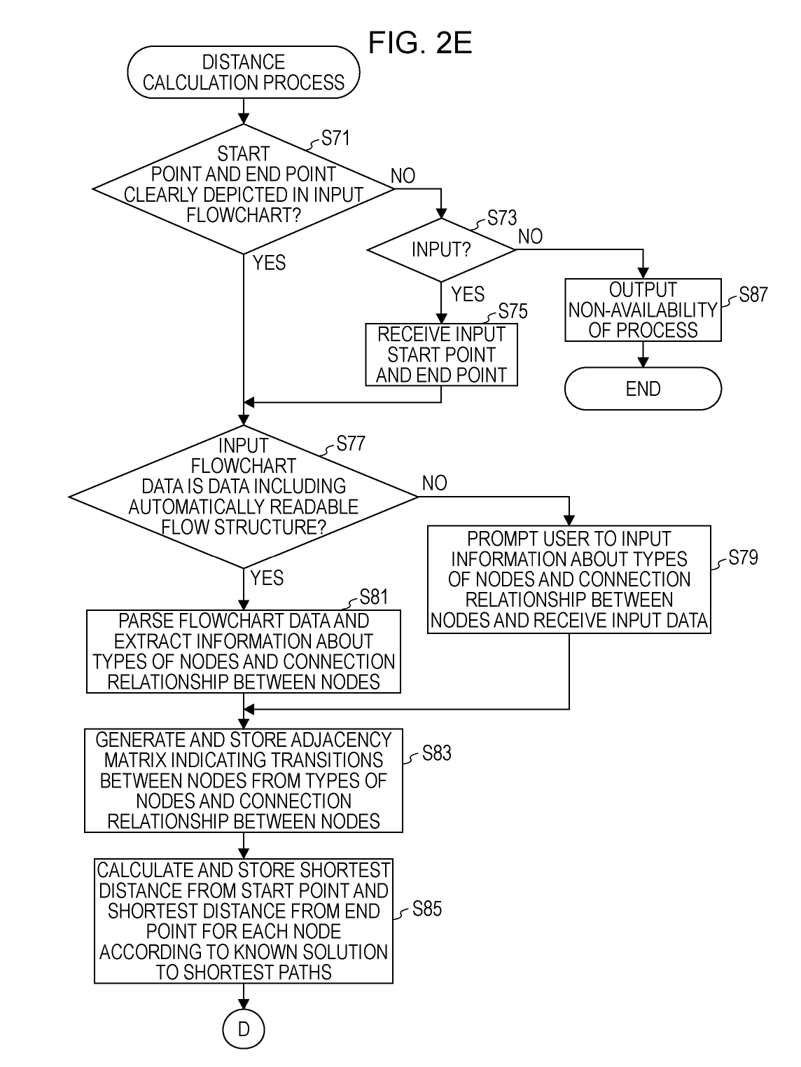

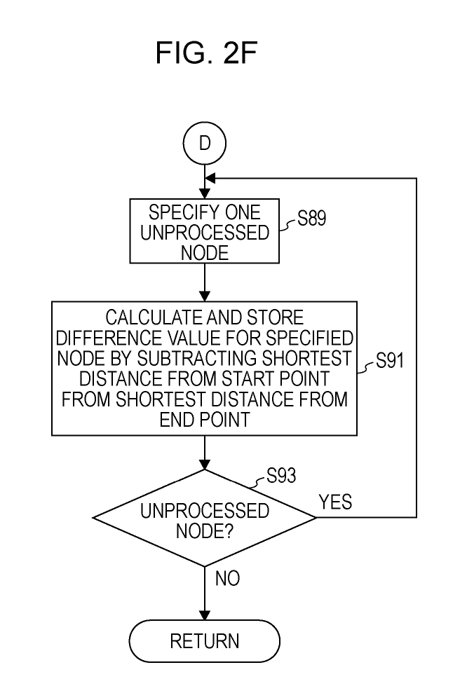

Next, the details of the process performed by the flow comparison processing apparatus 100 illustrated in FIG. 1 will be described with reference to FIGS. 2A to 32.

First, the process instance generation unit 101 generates a first process instance group from data accumulated in a first database group such as databases A and B, and stores the first process instance group in the process instance data storage unit 102 (FIG. 2A: step S1). This process is disclosed in, for example, Japanese Laid-open Patent Publication No. 2008-27072.

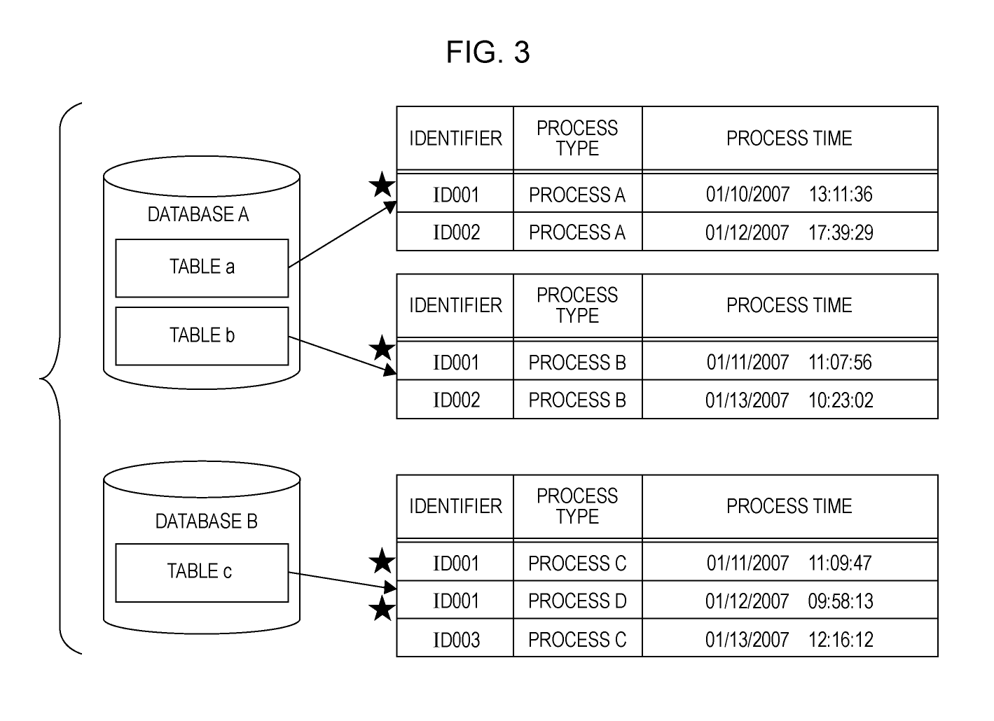

For example, as schematically illustrated in FIG. 3, the database A stores tables a and b. The process instance generation unit 101 extracts business records each including an identifier, a process type, and a process time from the table a, and also extracts business records each including an identifier, a process type, and a process time from the table b. The database B stores a table c, and business records each including an identifier, a process type, and a process time are extracted from the table c. If one record in the tables a to c does not include one of the identifier, process type, and/or process time columns, the process instance generation unit 101 refers to the table name or the like to obtain, for example, the process type to configure a business record including an identifier, a process type, and a process time in a manner illustrated in FIG. 3, and stores the business record in, for example, the process instance data storage unit 102.

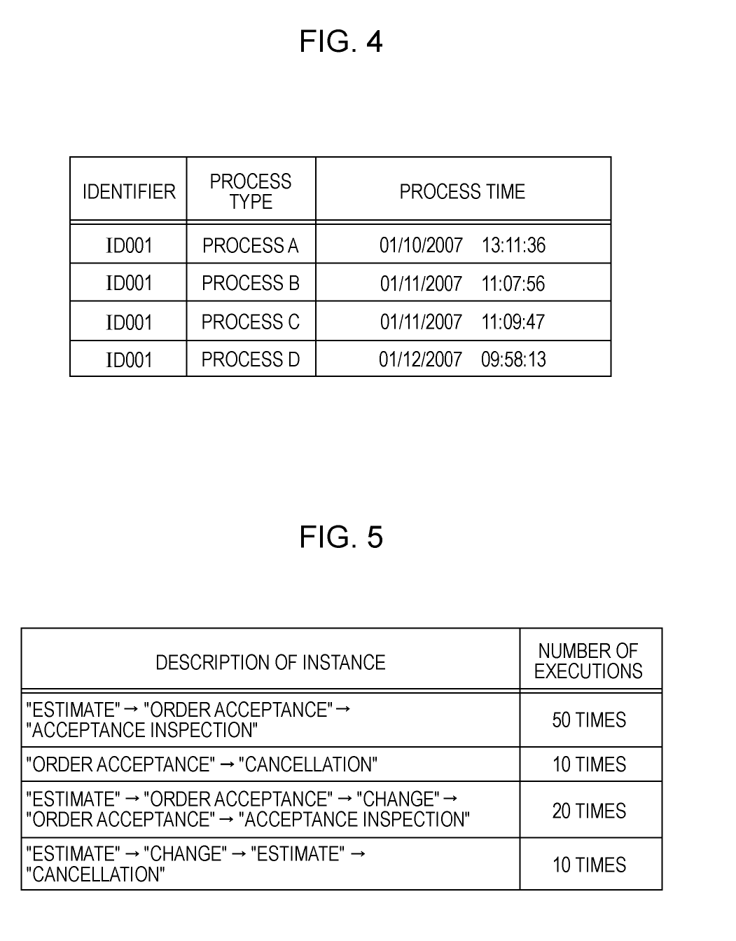

Then, the process instance generation unit 101 sorts the business records stored in the process instance data storage unit 102 by identifier and process time, and stores the sorted results in the process instance data storage unit 102. Records having the same identifier are records that are in a series of businesses for the same matter. The business records are grouped by identifier and are sorted by process time, thereby specifying the order of the businesses being performed. In the example illustrated in FIG. 3, the business records with identifier ID001, which are marked with a star, are grouped and are arranged in the order of the earliest process time, thereby generating data as illustrated in FIG. 4. The generated data is stored in the process instance data storage unit 102. Business records other than those with identifier ID001 are also grouped and sorted in a similar manner, and the resulting data is stored in the process instance data storage unit 102. Each of the records stored in the manner illustrated in FIG. 4 is an event (also referred to as an “event instance”), and a group of records which are arranged in time series is referred to as a “process instance.”

Subsequently, for example, the flowchart data obtaining unit 106 determines whether or not acquisition of flowchart data has been instructed by a user through the input unit 111, or whether or not a second database group (or a replica thereof), such as databases C and D indicated by dotted lines in FIG. 1, has been set or specified to determine whether or not a process instance is generated from the second database group. If a process instance is generated from the second database group (step S3: YES route), the process instance generation unit 101 generates a second process instance group from the data accumulated in the second database group such as the databases C and D, and stores the second process instance group in the process instance data storage unit 102 (step S5). The processing of step S5 is the same as that of step S1. Then, the process proceeds to step S9.

On the other hand, if flowchart data is obtained (step S3: NO route), the flowchart data obtaining unit 106 obtains data representing a flow structure (such as, for example, image data of a flowchart or data defining a computer-readable flow structure which is described in Extensible Markup Language (XML) Process Definition Language (XPDL) which is a standard format defined for exchanging business process definitions between workflow products (modeling engines or workflow engines) or any other suitable language) from an external resource, and stores the obtained data in the flowchart data storage unit 107 (step S7).

After step S5 or S7, the event belonging section determination processing unit 103 performs a most frequent event occurrence position evaluation process on the first process instance group (step S9). The most frequent event occurrence position evaluation process will be described with reference to FIGS. 2B to 10.

First, the event belonging section determination processing unit 103 specifies one unprocessed process instance from the process instance group stored in the process instance data storage unit 102 (FIG. 2B: step S51). The event belonging section determination processing unit 103 also counts the number of events included in the specified process instance, and calculates an occurrence position of each of the events based on the count value (step S53).

For example, as illustrated in FIG. 5, in the process instance data storage unit 102, four process instances have been generated: namely, a first process class in which events occur in the order of “estimate”->“order acceptance”->“acceptance inspection”, a second process class in which events occur in the order of “order acceptance”->“cancellation”, a third process class in which events occur in the order of “estimate”->“order acceptance”->“change”->“order acceptance”->“acceptance inspection”, and a fourth process class in which events occur in the order of “estimate”->“change”->“estimate”->“cancellation”. As illustrated in FIG. 5, the number of executions for each process class is also specified.

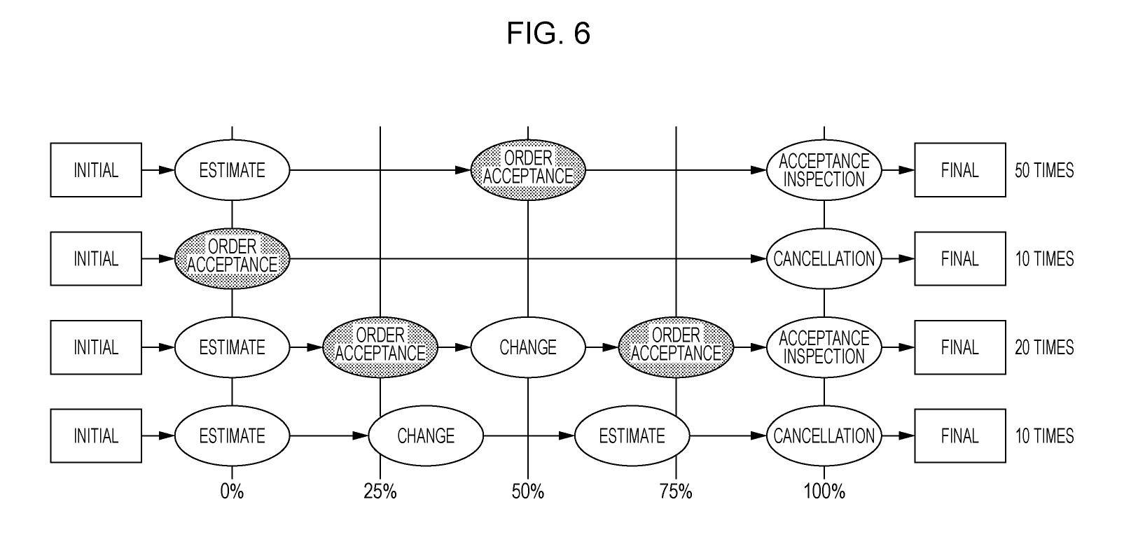

In this case, in step S53, an occurrence position is calculated using a method as illustrated in FIG. 6. More specifically, the position of the first event and the position of the last event are set to 0% and 100%, respectively, and the positions of the events that occur therebetween are determined so that the intervals between the events are equal. In the case of the first process class, as illustrated in the first row of FIG. 6, only the “order acceptance” event occurs between the first and last events. Thus, two intervals occur. The position of the “order acceptance” event is therefore given by 100%/2=50%. In the case of the second process class, as illustrated in the second row of FIG. 6, since there are only two events, there is no intermediate event whose position is to be determined. In the case of the third process class, as illustrated in the third row of FIG. 6, the “order acceptance” event, the “change” event, and the second “order acceptance” event occur between the first and last events. Thus, four intervals occur. Therefore, the occurrence position of the “order acceptance” event is given by 100%/4*1=25%, the occurrence position of the “change” event is given by 100%/4*2=50%, and the occurrence position of the second “order acceptance” event is given by 100%/4*3=75%. In the case of the fourth process class, as illustrated in the fourth row of FIG. 6, the “change” event and the “estimate” event occur between the first and last events. Thus, three intervals occur. Therefore, the occurrence position of the “change” event is given by 100%/3*1=33.3%, and the occurrence position of the “estimate” event is given by 100%/3*2=66.6%.

In order to generate a frequency distribution, the number of occurrence positions of each event type is counted up by the number of executions for the process instance.

With the use of the above procedure, an occurrence position of each of the events included in the process instance specified in step S51 is calculated. In this manner, since occurrence positions are calculated in normalized forms in each process instance, the comparison may be made while reducing the influence of the difference in the number of nodes or events between flowcharts, which is caused by differences in granularity.

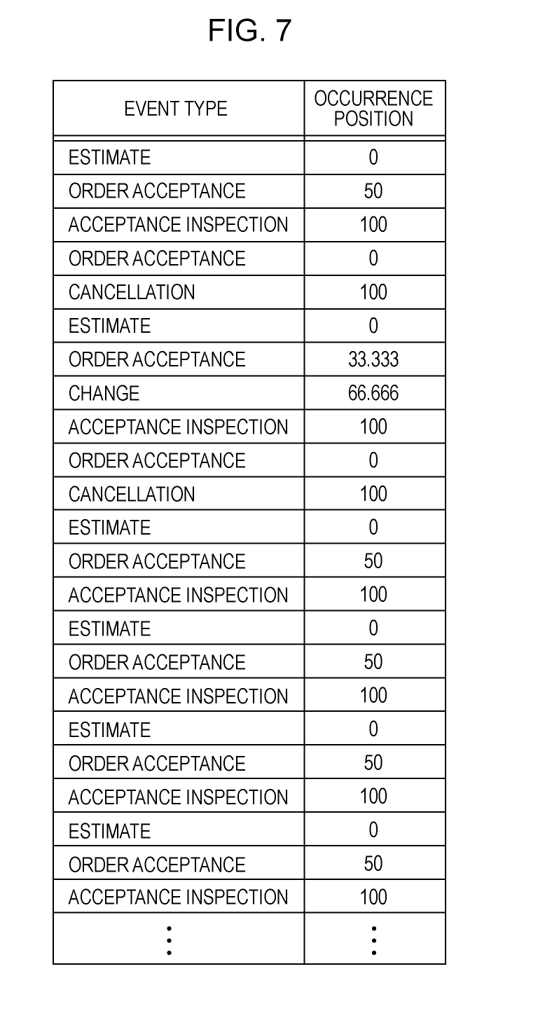

Then, the event belonging section determination processing unit 103 specifies one unprocessed event (step S55), and registers the event name (also called the “event type” or “event category”) and the occurrence position in an occurrence position management table in the event belonging section data storage unit 104 (step S57). The occurrence position management table is, for example, a table as illustrated in FIG. 7. In the example illustrated in FIG. 7, both an event type and an occurrence position are registered. In step S57, one record is registered in the occurrence position management table.

Then, the event belonging section determination processing unit 103 determines whether or not all the events have been processed (step S59). If an unprocessed event exists, the process returns to step S55. If no unprocessed event exists, it is determined whether or not all the process instances stored in the process instance data storage unit 102 have been processed (step S61). If an unprocessed process instance exists, the process returns to step S51. On the other hand, if all the process instances have been processed, the process proceeds to a process illustrated in FIG. 2C via the terminal B.

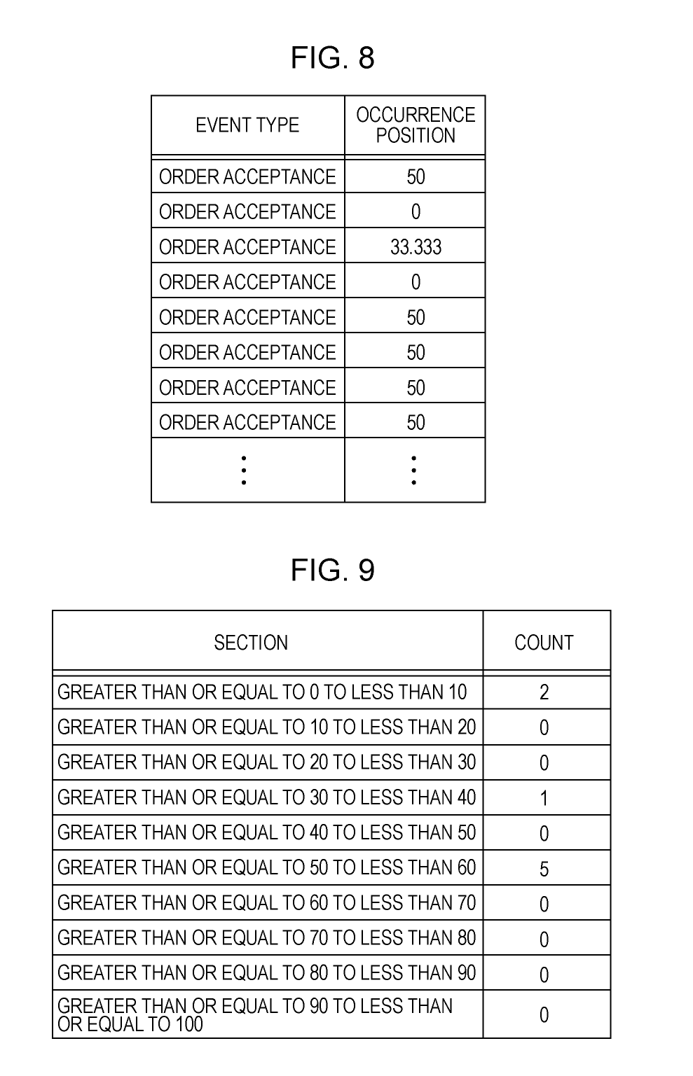

In the process illustrated in FIG. 2C, the event belonging section determination processing unit 103 specifies one unprocessed event type in the occurrence position management table (step S63). Then, records corresponding to the specified event type are extracted from the occurrence position management table, and the number of occurrences for each specific position section is counted and is stored in the event belonging section data storage unit 104 (step S65). For example, records of the “order acceptance” event indicated by hatching in FIG. 6 are extracted from the occurrence position management table as illustrated in FIG. 7. Then, data as illustrated in FIG. 8 may be obtained. That is, the occurrence positions of the records all of which have the event type “order acceptance” are listed. Then, for example, as illustrated in FIG. 9, the range from 0% to 100% is equally divided into ten sections, and the number of occurrences is counted in each section. When the number of the records seen in FIG. 8 is calculated, a distribution as illustrated in FIG. 9 is obtained with five at 50%, one at 33.3%, and two at 0%.

Then, the event belonging section determination processing unit 103 specifies a most frequent occurrence section from the distribution as illustrated in FIG. 9, and stores data for specifying the most frequent occurrence section and the event type in the event belonging section data storage unit 104 so that the data and the event type are associated with each other (step S67). The most frequent occurrence section is typically a section having the greatest number of occurrences but may be a section having any other statistical characteristic value, or may be specified by a user. The data for specifying the most frequent occurrence section is an ID of the section when each section is assigned an ID, or may be data such as data indicating the range from greater than or equal to 0 to less than 10. Then, it is determined whether or not all the event types have been processed (step S69). If an unprocessed event type exists, the process returns to step S63. On the other hand, if all the event types have been processed, the process returns to the original process.

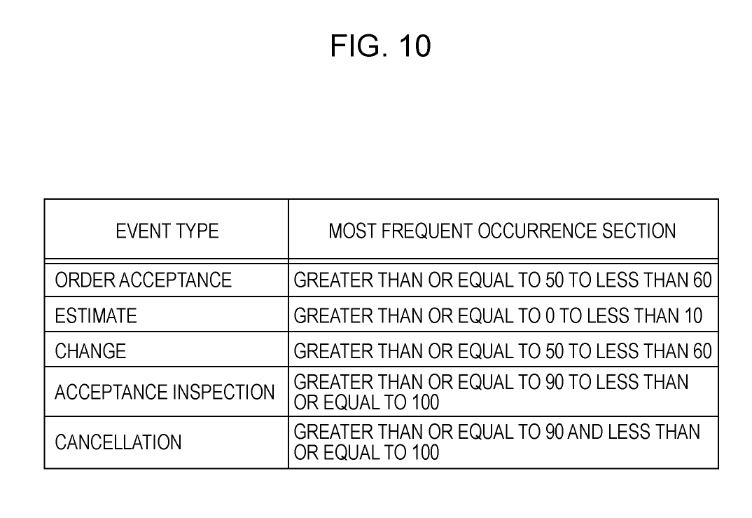

The process described above is performed, thereby specifying, for example, as illustrated in FIG. 10, the section ranging from greater than or equal to 0 to less than 10 as the most frequent occurrence section for the “estimate” event, the section ranging from greater than or equal to 50 to less than 60 as the most frequent occurrence section for the “order acceptance” event, the section ranging from greater than or equal to 50 to less than 60 as the most frequent occurrence section for the “change” event, the section ranging from greater than or equal to 90 to less than or equal to 100 as the most frequent occurrence section for the “acceptance inspection” event, and the section ranging from greater than or equal to 90 to less than or equal to 100 as the most frequent occurrence section for the “cancellation” event.

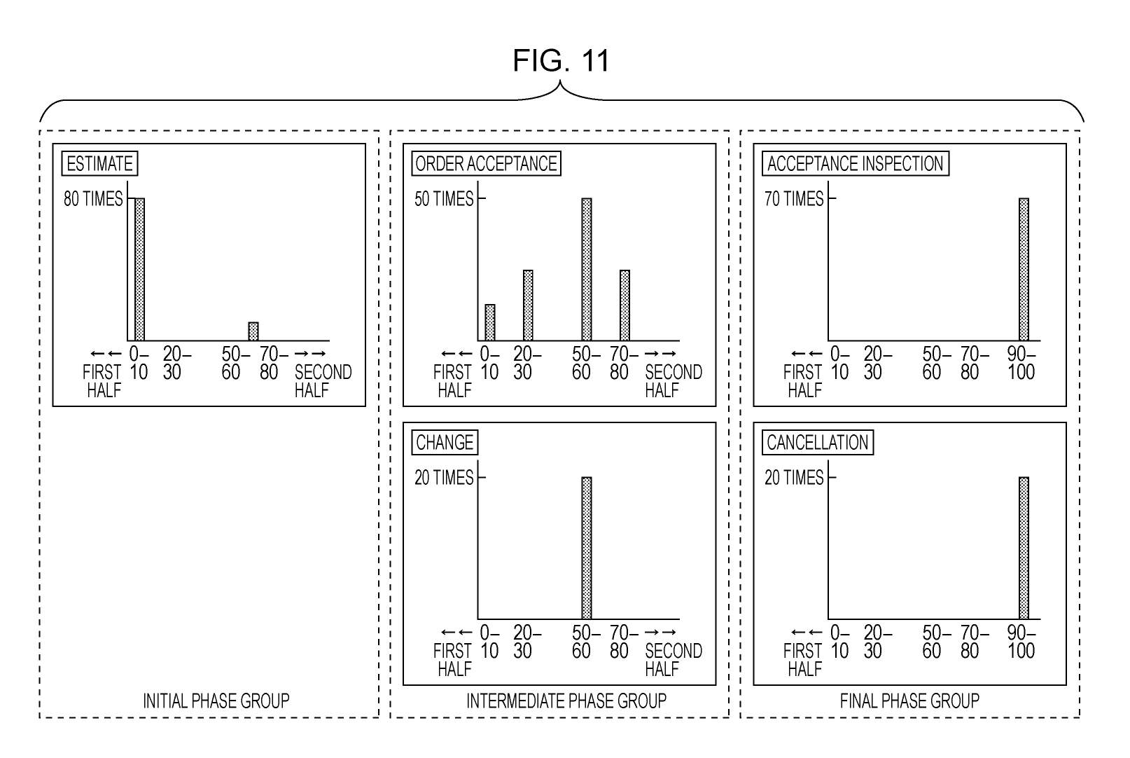

Referring back to FIG. 2A, the event belonging section determination processing unit 103 divides the event types in the first process instance group into groups based on the most frequent occurrence sections, and stores grouping data in the event belonging section data storage unit 104 (step S11). For example, the event types are divided into three groups: “initial phase”, “intermediate phase”, and “final phase”. In this case, an event type for which the most frequent occurrence section ranges from “greater than or equal to 0 to less than 10”, “greater than or equal to 10 to less than 20”, or “greater than or equal to 20 to less than 30” is designated as an event type belonging to the initial phase group. An event type for which the most frequent occurrence section ranges from “greater than or equal to 30 to less than 40”, “greater than or equal to 40 to less than 50”, “greater than or equal to 50 to less than 60”, or “greater than or equal to 60 to less than 70” is specified as an event type belonging to the intermediate phase group. In the example illustrated in FIG. 10, data as illustrated in FIG. 11 may be obtained. In the example illustrated in FIG. 11, the “estimate” event belongs to the initial phase group, the “order acceptance” and “change” events belong to the intermediate phase group, and the “acceptance inspection” and “cancellation” events belong to the final phase group. The example illustrated in FIG. 11 is also an example of the display described below, and further includes bar graphs. The event belonging section data storage unit 104 also stores data for drawing such bar graphs (FIG. 9). The process proceeds to a process illustrated in FIG. 2D via the terminal A.

The above process is performed, thereby specifying an appropriate occurrence section and group while reducing the influence of an exceptional flow path having a low frequency of occurrence.

In steps S9 and S11, the process is performed in such a manner that the event types are further grouped after the most frequent occurrence sections are specified. However, for example, three sections may be initially defined, such as that ranging from greater than or equal to 0 to less than 30, greater than or equal to 30 to less than 70, and greater than or equal to 70 to less than or equal to 100, and most frequent occurrence sections may be specified. In this case, however, results different from those in the processing of steps S9 and S11 may be obtained. Either method may be adopted as desired. Further, if the number of sections and the number of groups are the same, the processing of step S11 may not necessarily be performed.

In the process illustrated in FIG. 2D, when a process instance is generated from the second database group, in step S5 (step S13: YES route), the event belonging section determination processing unit 103 performs a most frequent event occurrence position evaluation process on the second process instance group stored in the process instance data storage unit 102 (step S15). This process is the same as that of step S9, and a detailed description thereof is omitted.

Further, the event belonging section determination processing unit 103 divides the event types in the second process instance group into groups based on most frequent occurrence sections in the same manner as that of the first process instance group, and stores grouping data in the event belonging section data storage unit 104 (step S17). This process is also the same as that of step S11, and a detailed description thereof is omitted. Note that grouping for the first and second process instance groups is desirably performed in the same manner. The process proceeds to step S25.

On the other hand, when flowchart data is obtained and is stored in the flowchart data storage unit 107 in step S5 (step S13: NO route), the node belonging section determination processing unit 108 performs a process for calculating a distance between a start point and an end point based on the flowchart data stored in the flowchart data storage unit 107 (step S19). This distance calculation process will be described with reference to FIGS. 2E to 2F.

The node belonging section determination processing unit 108 determines whether or not a start point and an end point are clearly depicted in an input flowchart (step S71). For example, when the input flowchart is written in a computer-readable language, predetermined keywords as well as terms such as “start” and “end” are registered in the node belonging section determination processing unit 108, and it is determined whether or not nodes matching the keywords are defined to determine whether or not a start point and an end point are clearly depicted. Even in image data, the above keywords may also be extracted using a technique such as optical character recognition (OCR).

If no start point or end point is clearly depicted in the input flowchart (if no start point or end point is actually depicted or if the node belonging section determination processing unit 108 has failed to identify a start point and an end point), for example, the node belonging section determination processing unit 108 provides a display on the display device 110 to prompt a user to input a start point and an end point. If no start point or end point is input (step S73: NO route), non-availability of the process is output and the subsequent process ends (step S87). Note that it is desirable to specify nodes to which the start point and the end point are connected.

On the other hand, if a start point and an end point are input through the input unit 111 (step S73: YES route), the node belonging section determination processing unit 108 receives the input start point and end point from the input unit 111, and stores the start point and the end point in a storage device such as, for example, a main memory (step S75).

After step S75, or if a start point and an end point are clearly depicted in an input flowchart, the node belonging section determination processing unit 108 determines whether or not the data of the input flowchart is data including an automatically readable flow structure (for example, data described in XPDL or the like) (step S77). If the input flowchart is formed by data that does not include a clearly readable flow structure, such as image data, the node belonging section determination processing unit 108 provides a display on the display device 110 to prompt a user to input information about the types of nodes and the connection relationship between the nodes to obtain input data from the user through the input unit 111, and stores the input data in a storage device such as, for example, a main memory (step S79). Then, the process proceeds to step S83.

If the data of the input flowchart is data that is an automatically readable flow structure (for example, data described in XPDL or the like), the node belonging section determination processing unit 108 parses the flowchart data using, for example, a known parser function, and extracts information about the types of nodes and the connection relationship between the nodes (step S81). The parser function may be implemented using the XML parser technology, and is not further described herein.

Then, the node belonging section determination processing unit 108 generates an adjacency matrix indicating transitions between nodes from the types of the node and the connection relationship between nodes, and stores the adjacency matrix in a storage device such as, for example, a main memory (step S83). The process proceeds to a process illustrated in FIG. 2F via the terminal D.

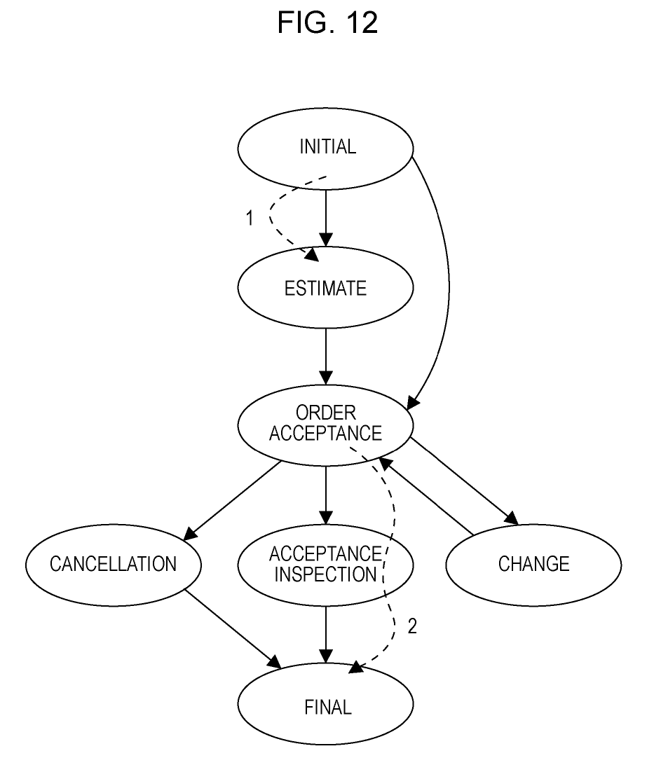

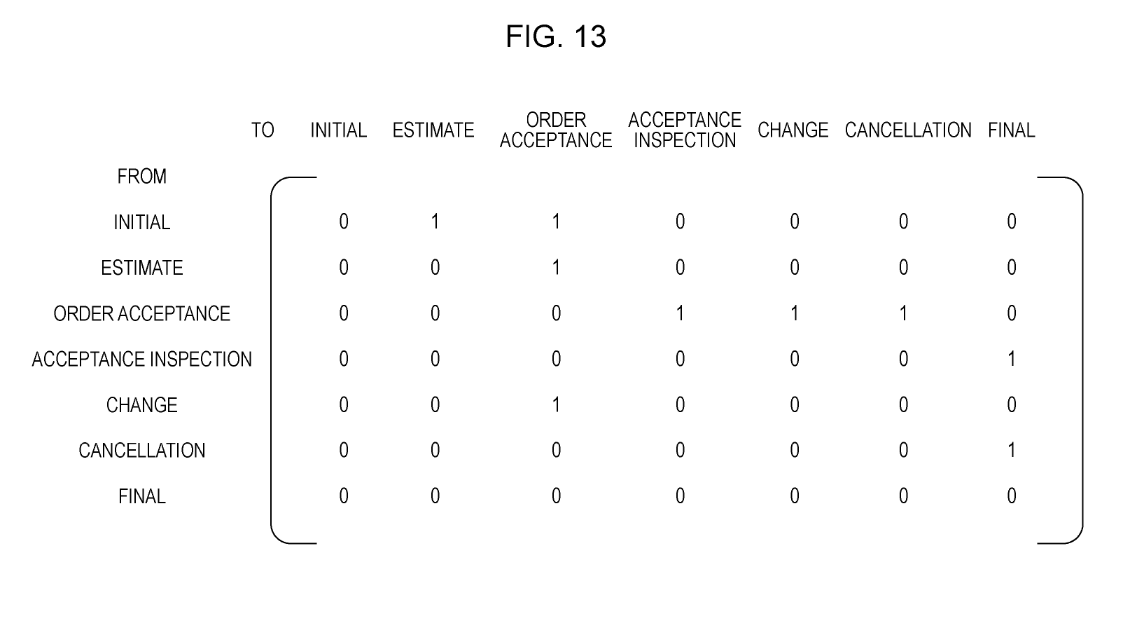

For example, a flowchart illustrated in FIG. 12 is assumed. The flowchart illustrated in FIG. 12 includes transitions from a start point, “INITIAL”, to “estimate” and “order acceptance”, a transition from “estimate” to “order acceptance”, transitions from “order acceptance” to “cancellation”, “acceptance inspection”, and “change”, a transition from “change” to “order acceptance”, a transition from “acceptance inspection” to an end point, “FINAL”, and a transition from “cancellation” to “FINAL”. When the above types of nodes and connection relationship between the nodes are converted into an adjacency matrix indicating the transitions between the nodes, a matrix as illustrated in FIG. 13 may be obtained. In the matrix, “0” denotes no transition and “1” denotes a transition.

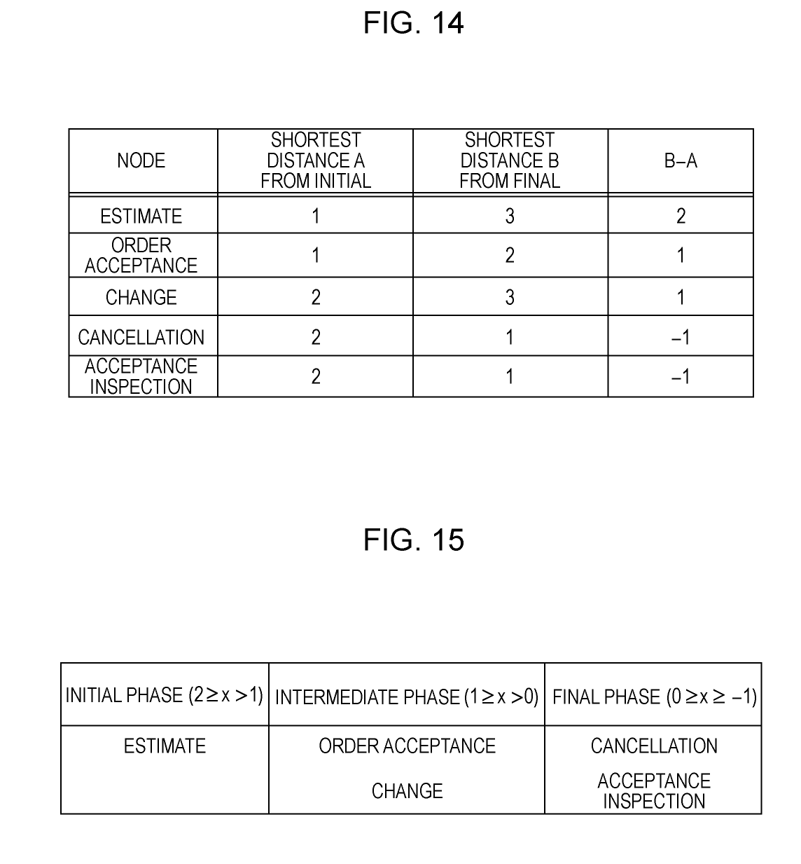

Then, the node belonging section determination processing unit 108 calculates the shortest distance from the start point and the shortest distance from the end point (which is the same as the shortest distance to the end point) for each of the nodes according to a known solution related to shortest paths in directed graphs, such as the Warshall-Floyd algorithm, and stores the shortest distances in the node belonging section data storage unit 109 (step S85). As illustrated in FIG. 12, for example, when looking at the “estimate”, the shortest distance from “INITIAL” is “1” and the shortest distance from “FINAL” is “3”. Further, when looking at the “order acceptance”, the shortest distance from “INITIAL” is “1” and the shortest distance from “FINAL” is “2”. The calculation of the shortest distances may be performed from an adjacency matrix using a known technique, and, for example, data as illustrated in, for example, FIG. 14 may be obtained as calculation results. That is, a shortest distance A from INITIAL and a shortest distance B from FINAL (which is the same as the shortest distance to FINAL) are calculated for each node. In the example illustrated in FIG. 14, calculation results B−A, which will be explained below, are also illustrated.

In the process illustrated in FIG. 2F, the node belonging section determination processing unit 108 specifies one unprocessed node (step S89). Then, the node belonging section determination processing unit 108 calculates a difference value (also referred to as a “distance difference”) for the specified node by subtracting the shortest distance from the start point from the shortest distance from the end point, and stores the difference value in the node belonging section data storage unit 109 (step S91). As illustrated in FIG. 14, the calculation of B−A is performed, and the results are registered. A node having a greater difference value is closer to INITIAL and a node having a smaller difference value is closer to FINAL. Therefore, a difference value is calculated as an index of how close to the start point or the end point a node is. Then, it is determined whether or not an unprocessed node exists (step S93). If an unprocessed node exists, the process returns to step S89. If no unprocessed node exists, the process returns to the original process.

The above process is performed, thereby obtaining data that the grouping of nodes, which will be performed below, is based on even if a flowchart is given.

Referring back to FIG. 2D, the node belonging section determination processing unit 108 divides the nodes into groups the number of which equals the number of groups of process instances based on the calculated difference values, and stores grouping data in the node belonging section data storage unit 109 (step S23). If the data as illustrated in FIG. 14 is obtained, for example, a node having a difference value x greater than 1 and less than or equal to 2 is defined to be included in the initial phase group, a node having a difference value x less than or equal to 1 and greater than 0 is defined to be included in the intermediate phase group, and a node having a difference value x less than or equal to 0 and greater than or equal to −1 is defined to be included in the final phase group. Which group each node belongs to is determined based on the difference value of the node. In the example illustrated in FIG. 14, as illustrated in FIG. 15, the initial phase group includes “estimate”, the intermediate phase group includes “order acceptance” and “change”, and the final phase group includes “cancellation” and “acceptance inspection”. A threshold value for each of the groups is determined and set in advance based on the number of nodes, the range of the difference values (the difference between the maximum value and the minimum value), and/or the like.

Then, after step S17 or S23, the display processing unit 105 displays the correspondences between events and nodes, and also receives an input given by the user through the input unit 111. Then, the display processing unit 105 stores event-node correspondence data in the correspondence data storage unit 112 (step S25). A variety of specific methods for implementing the processing of step S25 may be conceived.

[First Specific Example of Step S25]

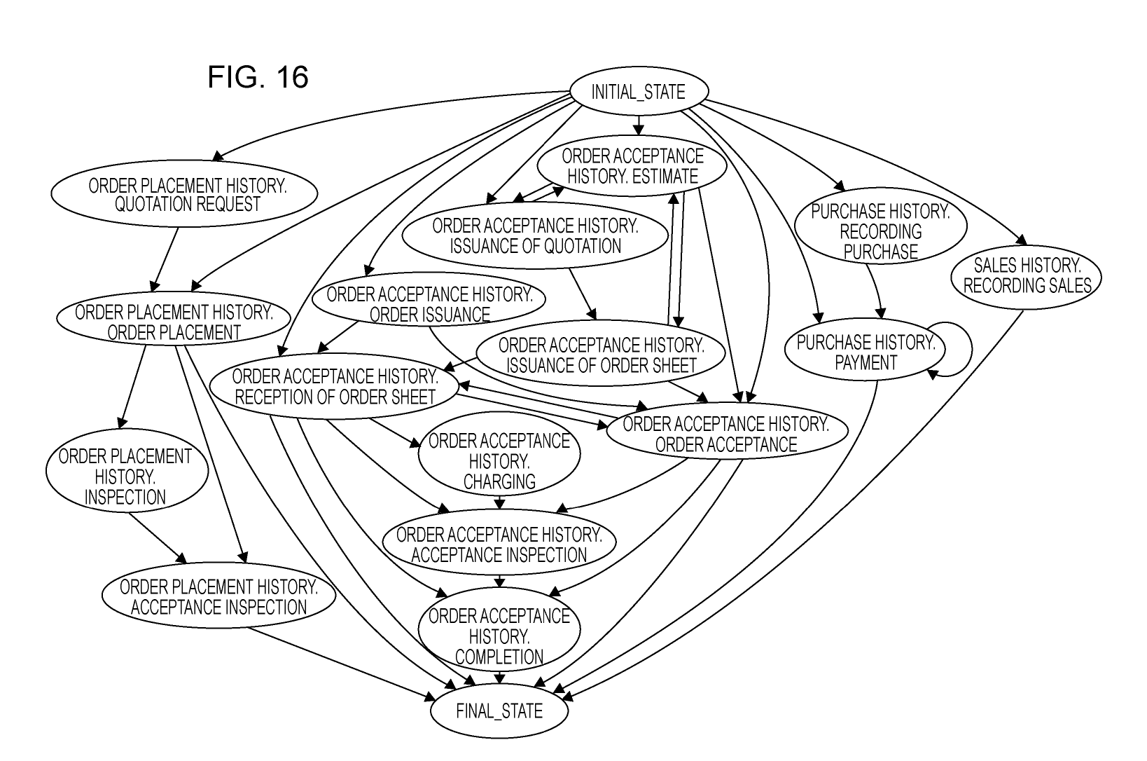

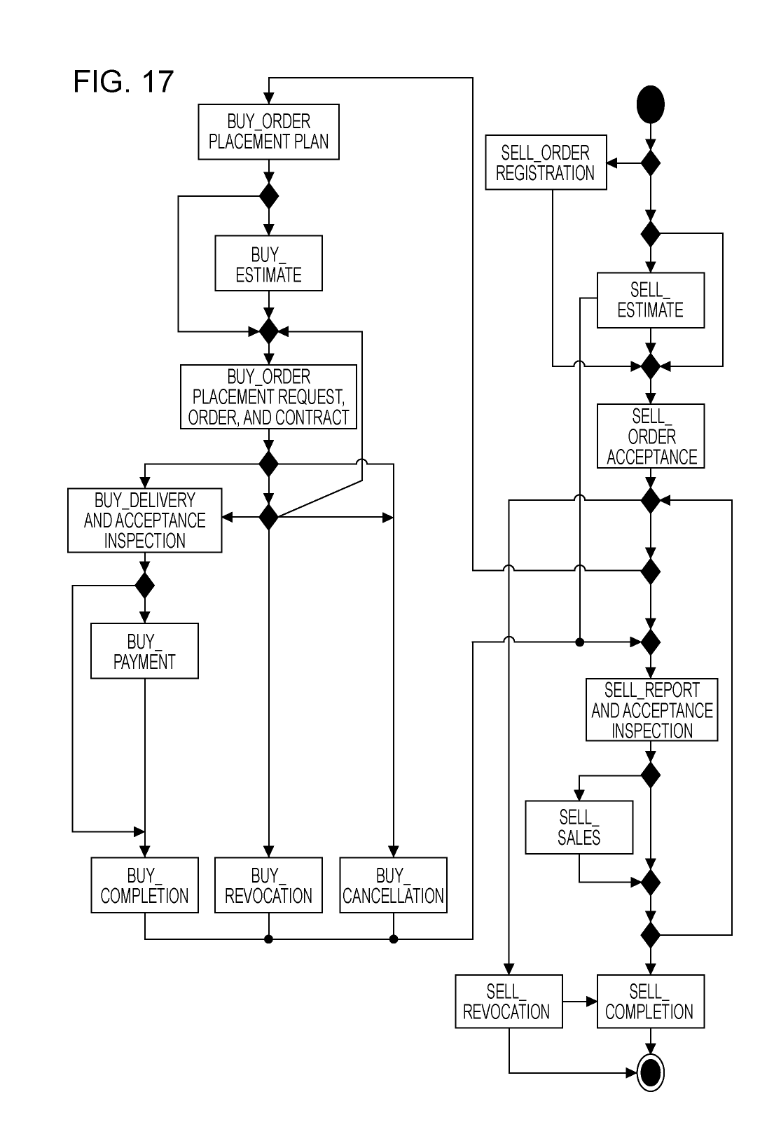

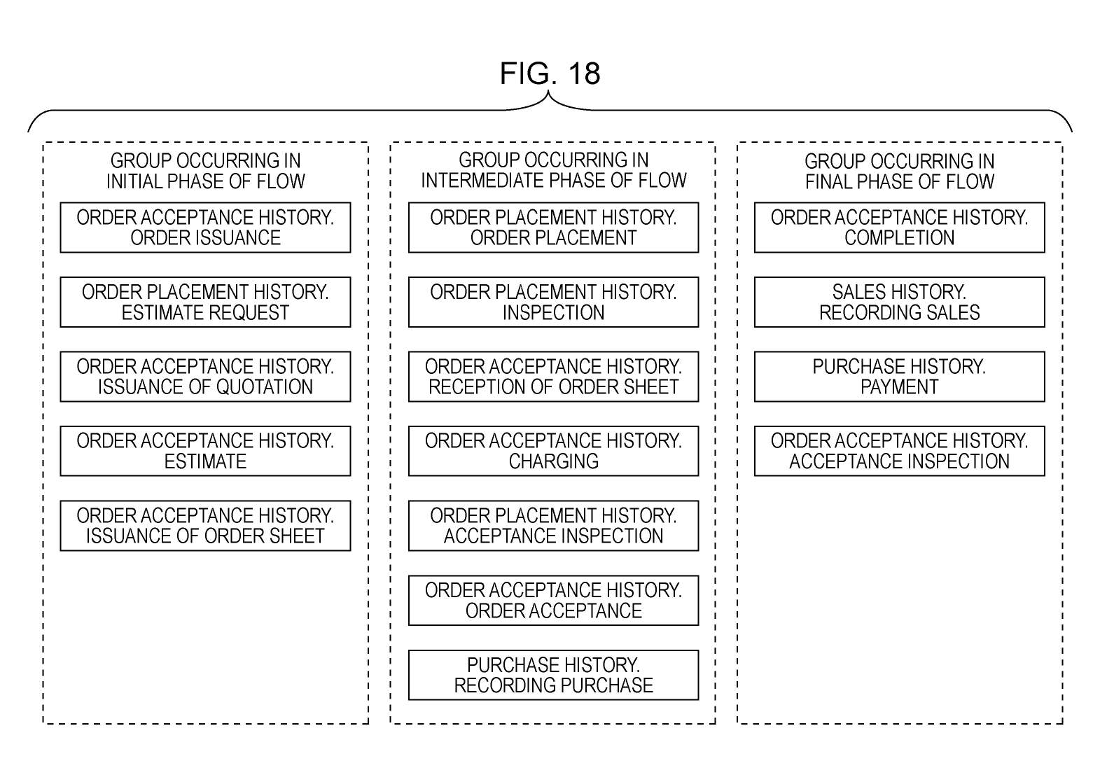

For example, when process instances are generated and are superimposed on each other, it is assumed that a first flow (business performance flow) as illustrated in FIG. 16 is obtained and that a flowchart as illustrated in FIG. 17 is input as a second flow (design flow). In this case, the process described above is performed on the first flow, resulting in the grouping as illustrated in FIG. 18. For example, the event types belonging to the initial phase group include “order acceptance history. order issuance”, “order placement history. estimate request”, “order acceptance history. issuance of quotation”, “order acceptance history. estimate”, and “order acceptance history. issuance of order sheet”. The event types belonging to the intermediate phase group include “order placement history. order placement”, “order placement history. inspection”, “order acceptance history. reception of order sheet”, “order acceptance history. charging”, “order placement history. acceptance inspection”, “order acceptance history. order acceptance”, and “purchase history. recording purchase”. The event types belonging to the final phase group include “order acceptance history. completion”, “sales history. recording sales”, “purchase history. payment”, and “order acceptance history. acceptance inspection”. The above data is stored in the event belonging section data storage unit 104.

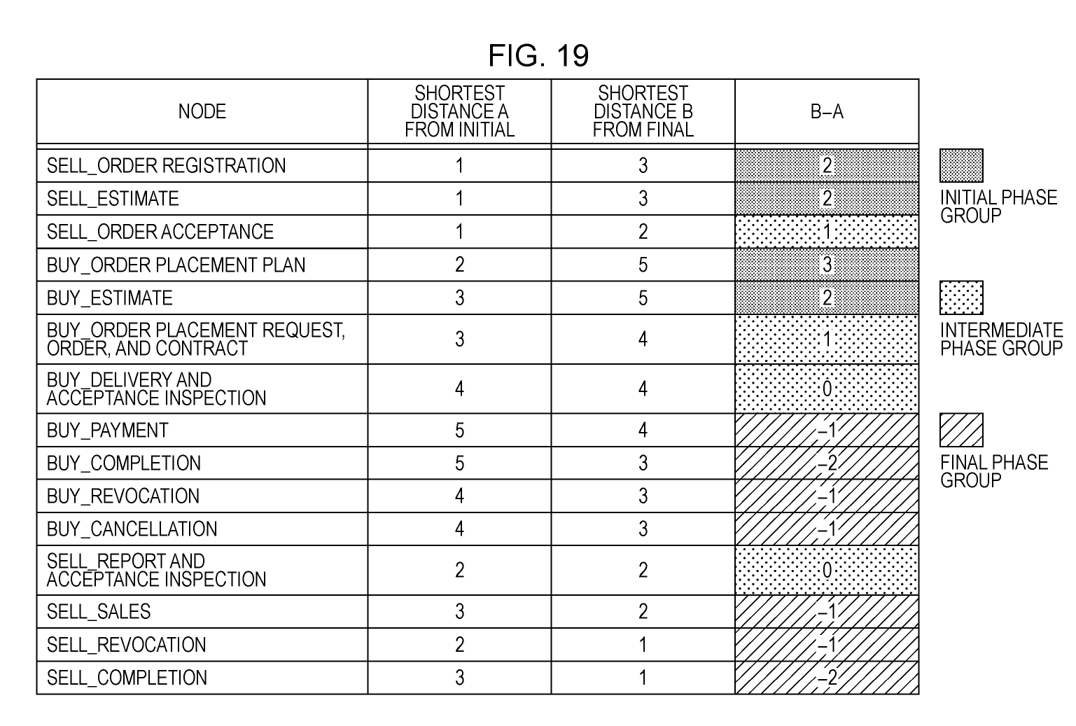

Further, if the process described above is performed on the second flow, as illustrated in FIG. 19, the individual nodes are classified into the initial phase group, the intermediate phase group, and the final phase group. For example, the nodes belonging to the initial phase group include “sell_order registration”, “sell_estimate”, “buy_order placement plan”, and “buy_estimate”. The nodes belonging to the intermediate phase group include “sell_order acceptance”, “buy_order placement request, order, and contract”, “buy_delivery and acceptance inspection”, and “sell_report and acceptance inspection”. The nodes belonging to the final phase group include “buy_payment”, “buy_completion”, “buy_revocation”, “buy_cancellation”, “sell_sales”, “sell_revocation”, and “sell_completion”. The above data is stored in the node belonging section data storage unit 109.

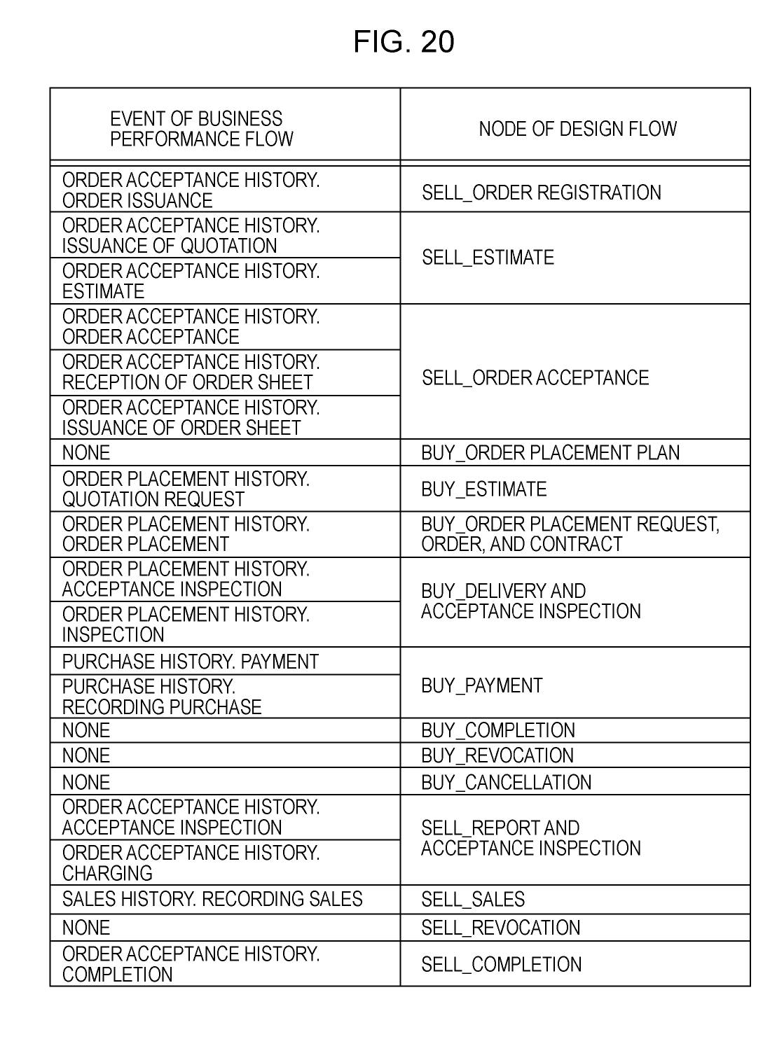

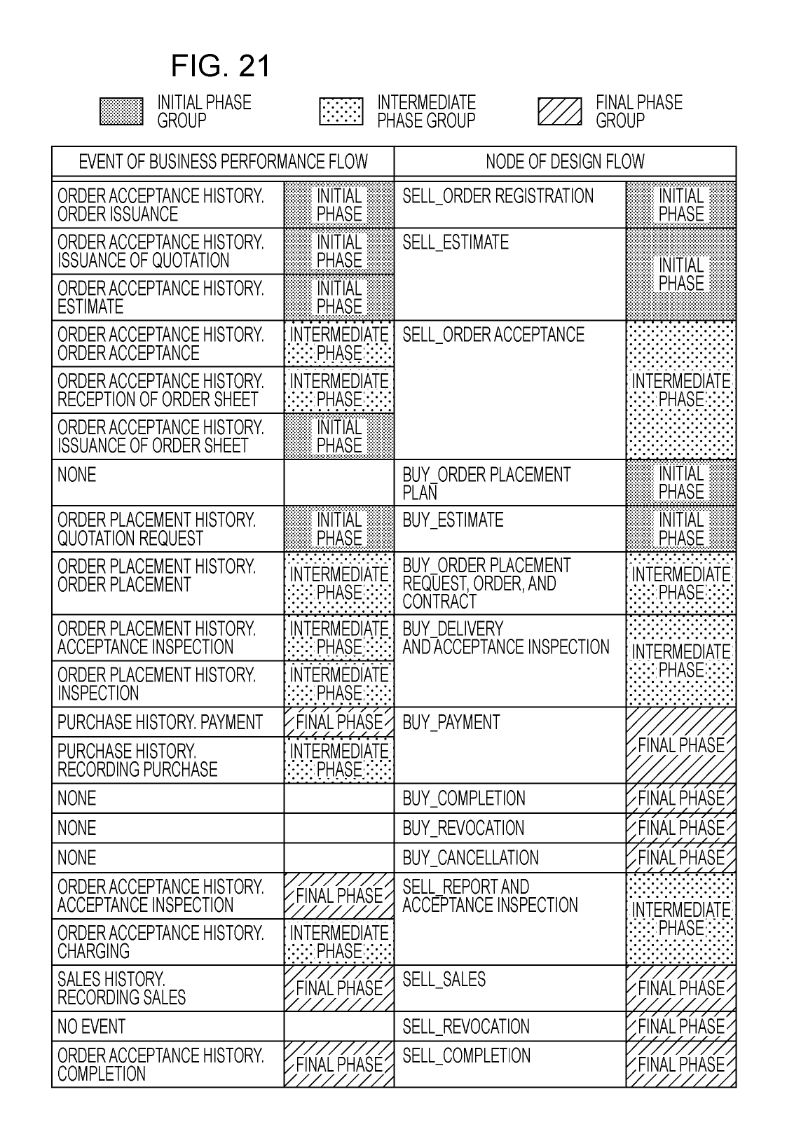

In the first specific example, a user inputs a correspondence relationship based on external documents through the input unit 111. The correspondence relationship may be, for example, as illustrated in FIG. 20. For example, there may be no correspondence relationship, or there may be a one-to-many correspondence relationship. Here, upon receipt of the input of such correspondence data, the display processing unit 105 stores the correspondence data in a storage device such as, for example, a main memory, and reads data that indicates to which group each node and each event belong to so as to prompt the user to check the validity of the correspondences made by the user. For example, a display as illustrated in FIG. 21 is provided. In the example illustrated in FIG. 21, while the correspondence relationship instructed by the user is maintained, indications of the initial phase, the intermediate phase, or the final phase are provided on the left side. Then, for example, when an event and a node that are included in the same group are associated with each other, the user determines that there is no specific problem, and determines the validity of a portion where an event and a node that are included in different groups are associated with each other. Additionally, there may be a need for a review when an event included in the initial phase and a node included in the final phase are associated with each other.

The user refers to the display as illustrated in FIG. 21 to re-check the correspondences, and instructs registration through the input unit 111 if there is no problem. Thus, the correspondence data as illustrated in FIG. 20 is stored in the correspondence data storage unit 112. If modification is needed, on the other hand, the user performs modification input through the input unit 111, and stores the modified correspondence data in the correspondence data storage unit 112.

In this manner, after the user inputs correspondence data, the determination of whether or not the input data is correct is performed using, as a factor, the data stored in the event belonging section data storage unit 104 and the node belonging section data storage unit 109. The graphs as illustrated in FIG. 11 may be presented and/or the data as illustrated in FIG. 19 may be displayed.

[Second Specific Example of Step S25]

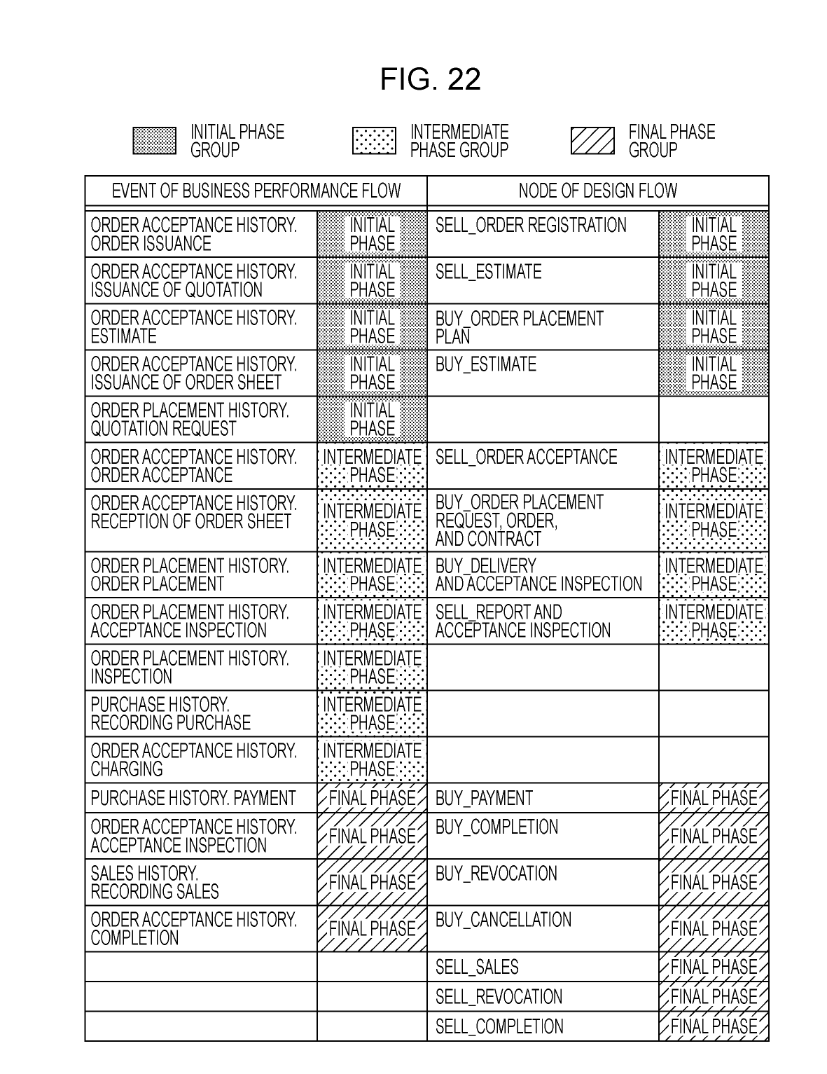

Conversely to the first specific example, for example, as illustrated in FIG. 22, first, the correspondences between the events and nodes belonging to the initial phase group are listed, the correspondences between the events and nodes belonging to the intermediate phase group are listed, and the correspondences between the events and nodes belonging to the final phase group are listed. Based on such group-based correspondence data and external documents, a user inputs an event and a node to be actually associated with each other through the input unit 111.

In this manner, after the data items stored in the event belonging section data storage unit 104 and the data items stored in the node belonging section data storage unit 109 are collectively presented group by group, correspondence data may be input based on such data items and the like.

Further, the events illustrated in FIG. 22 may be represented as buttons which are clicked on or the like, thereby displaying the bar graphs as illustrated in FIG. 11. Alternatively, another button may be provided so that, for example, the first and second flowcharts may be displayed in accordance with an instruction given by a user. In addition, the data stored in the event belonging section data storage unit 104 and the node belonging section data storage unit 109 may also be displayed.

[Third Specific Example of Step S25]

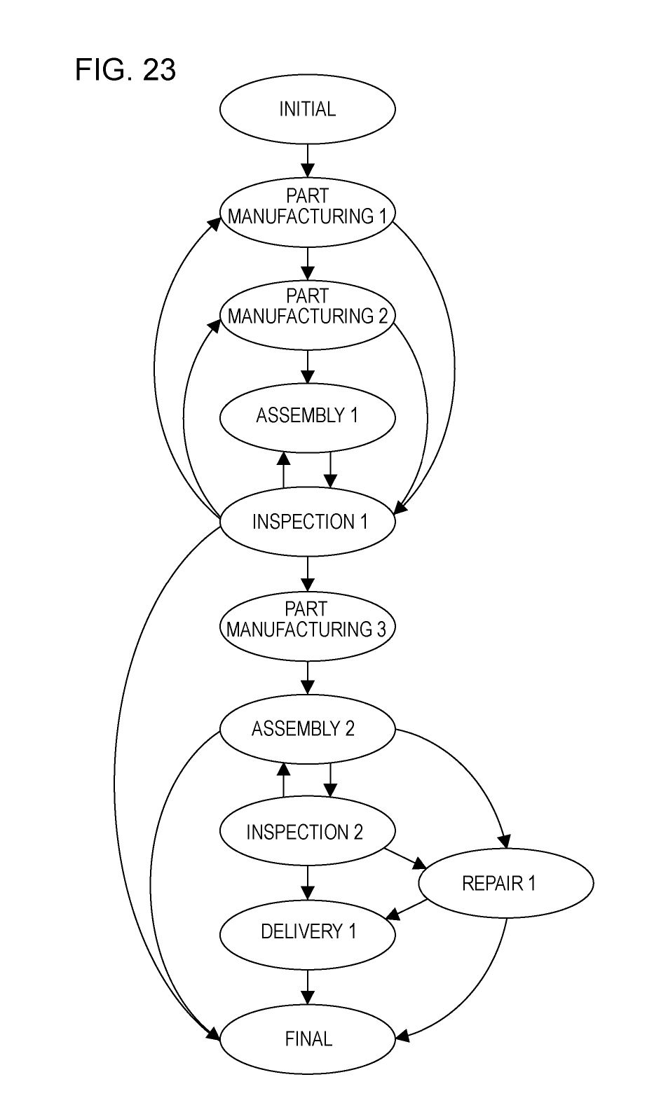

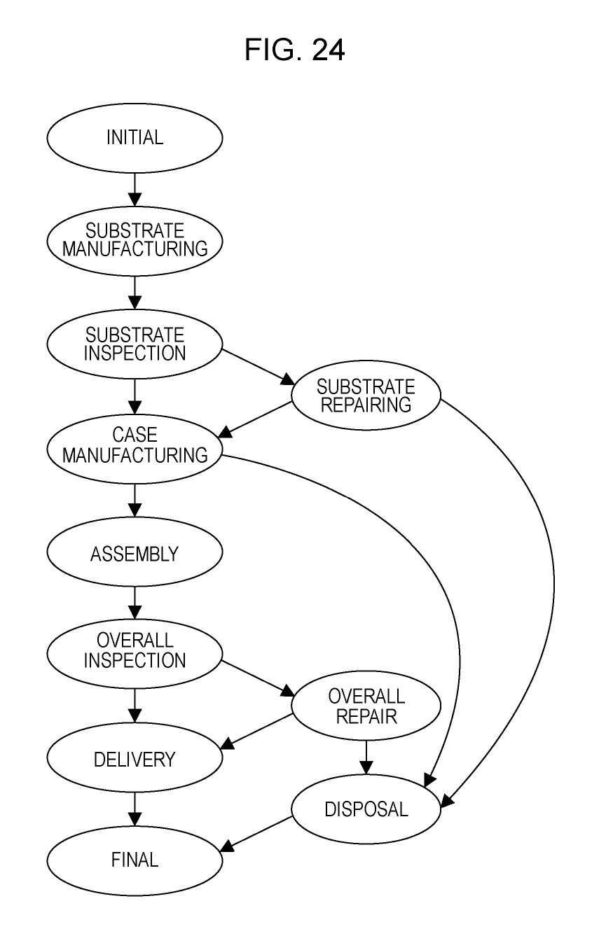

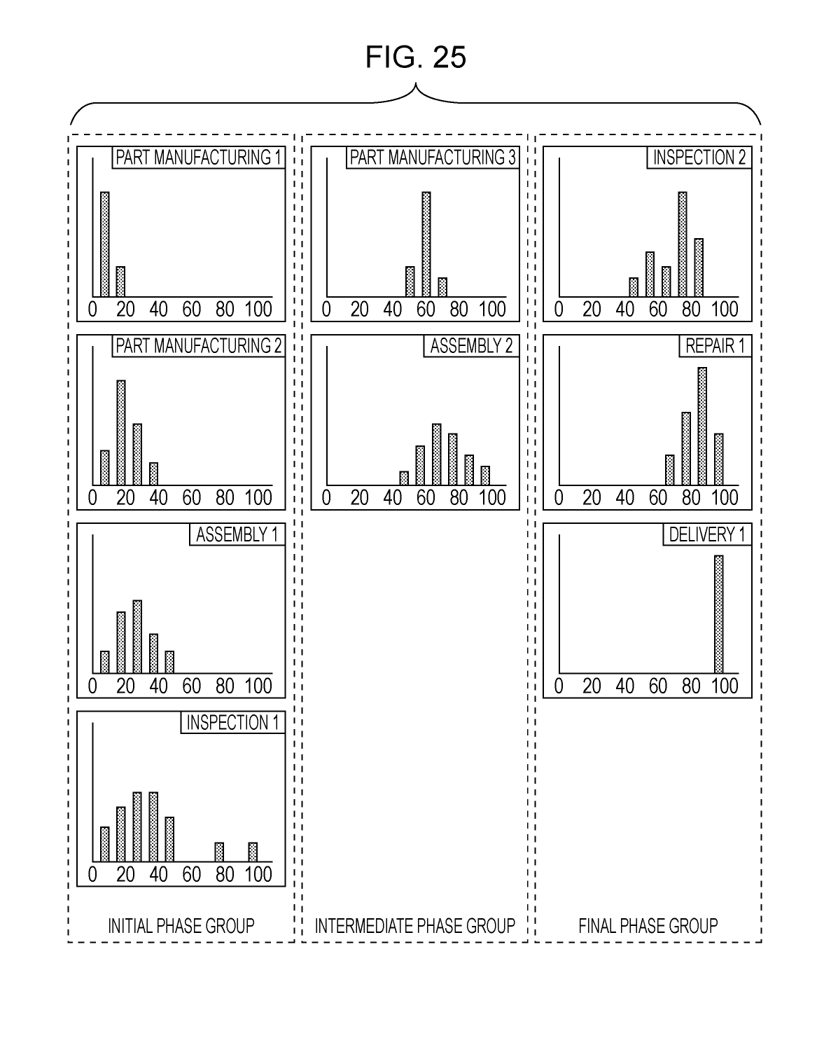

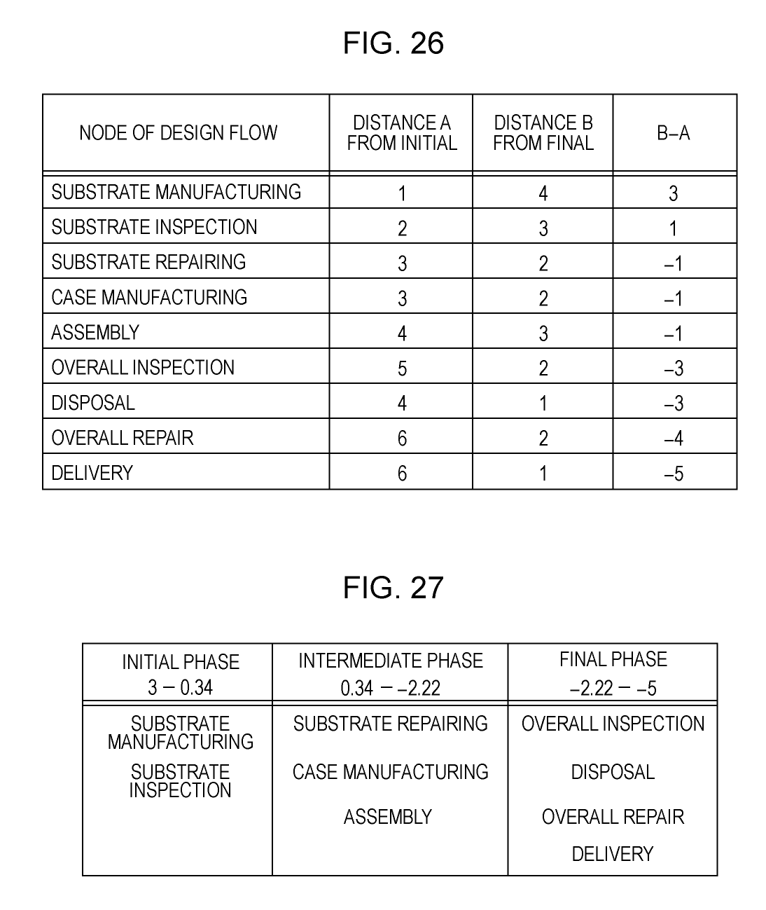

Here, a description will be given with reference to a first flow (business performance flow) illustrated in FIG. 23 and a second flow (design flow) illustrated in FIG. 24. It is assumed that grouping of events as illustrated in FIG. 25 is specified using the process performed by the event belonging section determination processing unit 103 described above. For example, the initial phase group includes “part manufacturing 1”, “part manufacturing 2”, “assembly 1”, and “inspection 1”, the intermediate phase group includes “part manufacturing 3” and “assembly 2”, and the final phase group includes “inspection 2”, “repair 1”, and “delivery 1”. Furthermore, it is assumed that the process performed by the node belonging section determination processing unit 108 is performed, thereby calculating a difference value (given by subtracting the distance from the start point from the distance from the end point, which equals the distance difference) for each node as illustrated in FIG. 26 and specifying grouping as illustrated in FIG. 27. As illustrated in FIG. 26, the difference values range from −5 to 3. Unlike the examples described above, as illustrated in FIG. 27, for example, a node having a difference value less than or equal to 3 and greater than 0.34 is classified into the initial phase group, a node having a difference value less than or equal to 0.34 and greater than −2.22 is classified into the intermediate phase group, and a node having a difference value less than or equal to −2.22 and greater than or equal to −5 is classified into the final phase group. That is, the initial phase group includes “substrate manufacturing” and “substrate inspection”, the intermediate phase group includes “substrate repairing”, “case manufacturing”, and “assembly”, and the final phase group includes “overall inspection”, “disposal”, “overall repair”, and “delivery”.

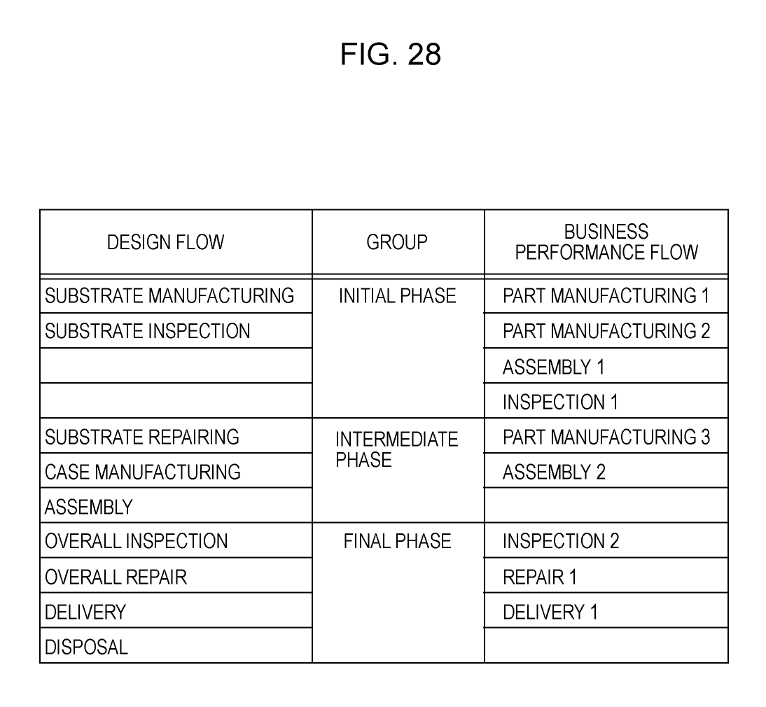

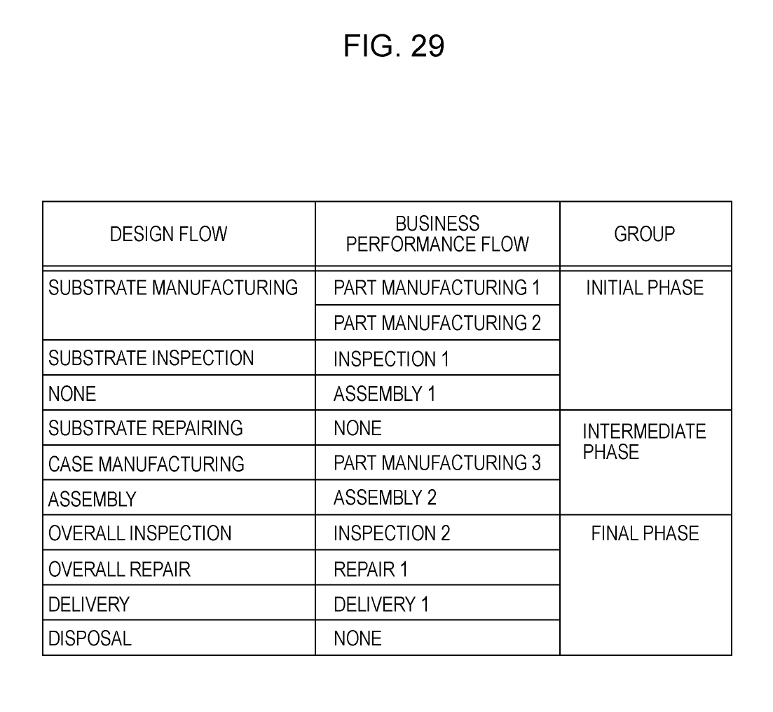

Then, group-based correspondences as illustrated in FIG. 28 may be obtained based on the grouping data stored in the event belonging section data storage unit 104 and the node belonging section data storage unit 109. In this stage, the display processing unit 105 associates a node in the design flow and an event in the business performance flow, which are in the same group, with each other by performing known character string matching. That is, a node name and an event name that have more matching characters are associated with each other. Thus, data as illustrated in FIG. 29 may be obtained. That is, the “substrate manufacturing” node is associated with the “part manufacturing 1” and “part manufacturing 2” events, the “substrate inspection” node is associated with the “inspection 1” event, the “case manufacturing” node is associated with the “part manufacturing 3” event, the “assembly” node is associated with the “assembly 2” event, the “overall inspection” node is associated with the “inspection 2” event, the “overall repair” node is associated with the “repair 1” event, and the “delivery” node is associated with the “delivery 1” event. The remaining nodes and events have no correspondences. For example, the display processing unit 105 generates the data as illustrated in FIG. 29 and presents the data to the user using the display device 110, and the user refers to external documents and the like to determine the validity of the correspondence relationship as illustrated in FIG. 29. If modification is needed, the modified content is input through the input unit 111, and the display processing unit 105 stores the modified correspondence data in the correspondence data storage unit 112. If no modification is needed, a registration instruction is input through the input unit 111, and the display processing unit 105 stores the content illustrated in FIG. 29 in the correspondence data storage unit 112.

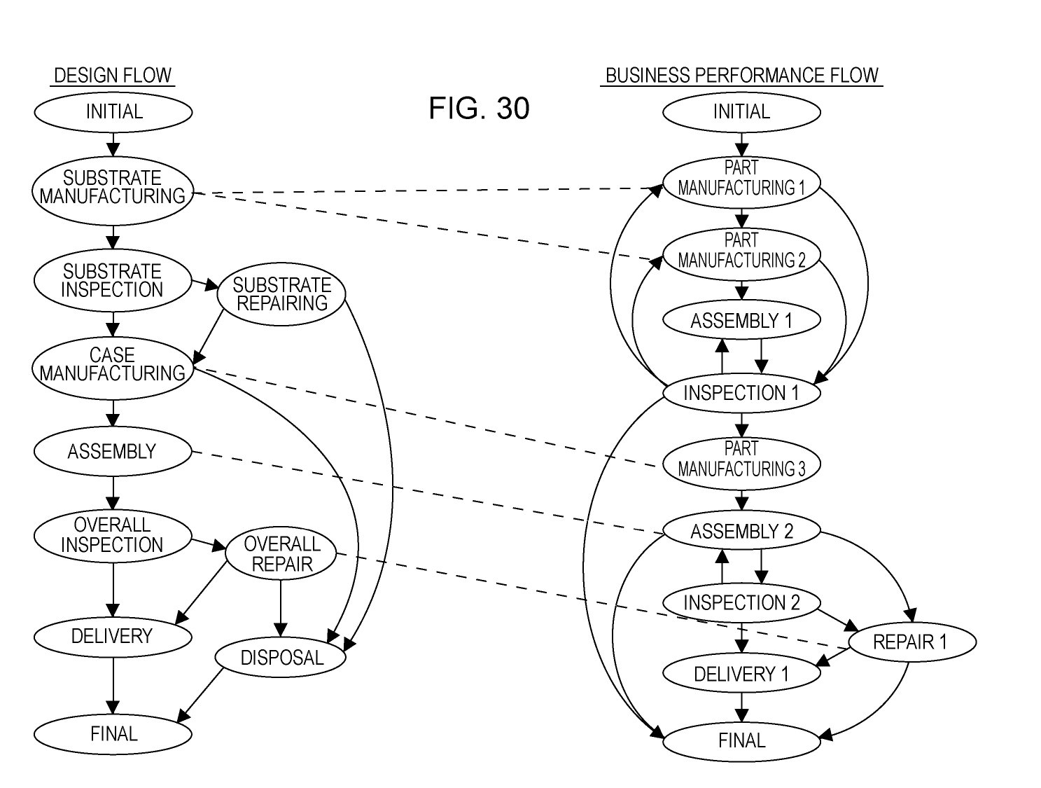

Alternatively, instead of displaying the table as illustrated in FIG. 29, for example, as illustrated in FIG. 30, flowcharts may be provided side by side to illustrate the correspondences between the nodes and the events. The correspondence relationship is similar to that illustrated in FIG. 29. In FIG. 30, correspondences are indicated by dotted lines. Instead of using dotted lines, lines may be drawn in colors so that the individual correspondences may be identified. The display as illustrated in FIG. 30 facilitates easy recognition of which node in the flow and which event in the flow are associated with each other. Therefore, a portion to be modified may also be specified. In the example illustrated in FIG. 30, the dotted lines representing correspondences extend relatively horizontally allow for the understanding that the correspondences are made with the positional relationship in the flows taken into consideration.

Furthermore, for example, the data as illustrated in FIGS. 25 to 27 may be displayed in accordance with a request given by a user.

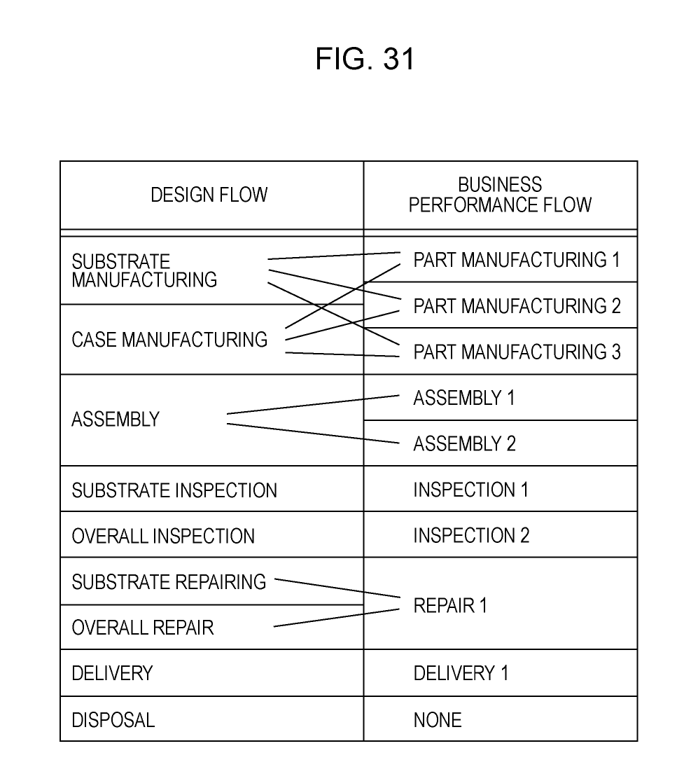

In contrast, if the nodes in the design flow and the events in the business performance flow are associated with each other using simple character string matching without using the grouping as described above, a node and an event, which are not to be associated with each other in the flows, may be associated with each other. This situation is illustrated in FIG. 31. It is not clearly understood which of the “part manufacturing 1” event, the “part manufacturing 2” event, and the “part manufacturing 3” event the “manufacture of substrate” node and the “manufacture of case” node are associated with. This presents a problem in that it may not be distinguished whether 1: n (where n is an integer of 2 or more) correspondences are originally involved or 1: n correspondences are caused by the reflection of ambiguity in the character string matching. Furthermore, the same applies to the correspondence relationship between the “assembly” node and the “assembly 1” and “assembly 2” events and the correspondences between the “substrate repairing” and “overall repair” nodes and the “repair 1” event. The character string matching by itself is insufficient to clarify the correspondences between the “substrate inspection” and “overall inspection” nodes and the “inspection 1” and “inspection 2” events. However, here, from the context in the flows, as illustrated in FIG. 31, the “substrate inspection” node and the “inspection 1” event are associated with each other, and the “overall inspection” node and the “inspection 2” event are associated with each other. Even with the use of such a rule, if character string matching is performed first, the ambiguity is left unresolved. In addition, the need for matching between many nodes and events requires further calculation cost for the matching.

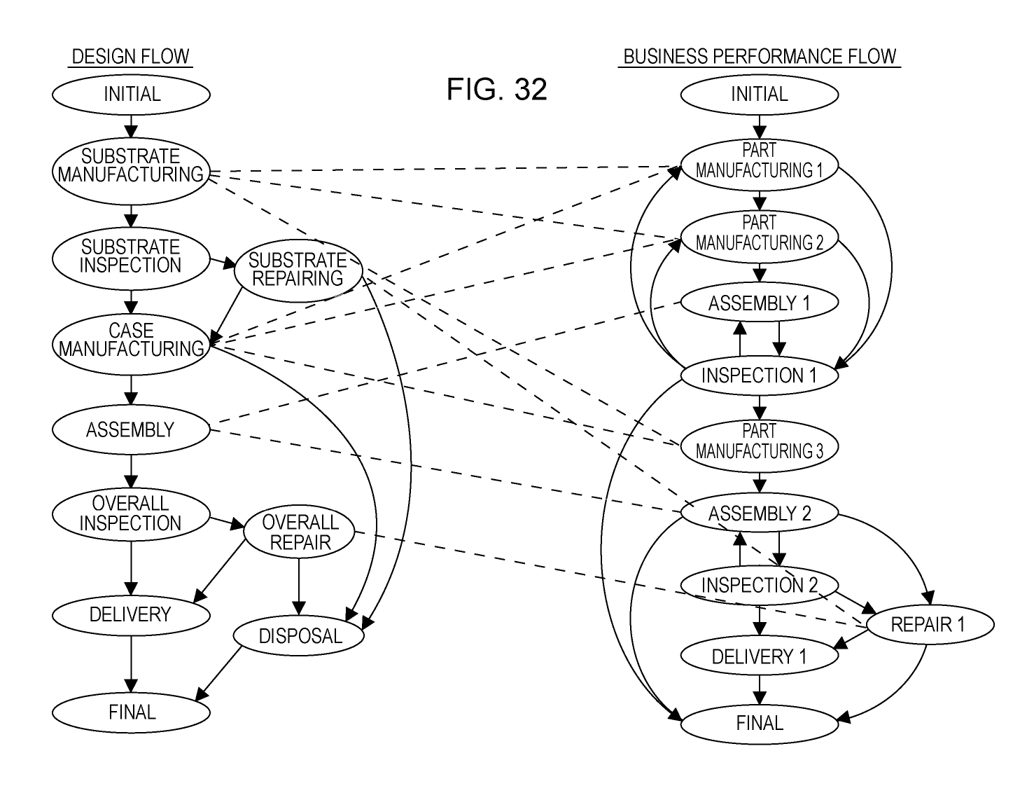

Therefore, when flowcharts are provided side by side for comparison in the manner as in FIG. 30, a figure as illustrated in FIG. 32 may be obtained. It may be seen that the crossing of dotted lines representing the correspondences exhibits more complexity than that in FIG. 30. In particular, some of the dotted lines that extend diagonally connect nodes and events. Thus it may be understood that the correspondences in terms of the positional relationship in the flows are poor.

Accordingly, the use of results of the grouping described above may provide improved accuracy of correspondences while saving time and labor required for a user to modify correspondences.

While the present embodiment of the present technique has been described, the present technique is not to be limited thereto. For example, the functional block diagram illustrated in FIG. 1 is merely an example, and may not necessarily reflect the actual program module configuration.

Furthermore, the order of processes in a process flow may also be changed or the processes may be executed in parallel unless the process results are changed.

Furthermore, while the embodiment described above is based on a stand-alone type, the embodiment may be modified into that based on a client-server type. For example, when connected to a network, the exchange of data with a user terminal having a display device or an input device allows the flow comparison processing apparatus 100 which includes an interface unit with the user terminal in place of the display device 110 or the input unit 111 to perform processing.

A variety of modifications may also be made to the content displayed on the screen, and the display content described above is not to be construed as limiting. As far as similar content may be displayed, other modifications of the content may be displayed. Further, other information may be additionally displayed or the content of pieces of information to be displayed at the same time may be chosen.

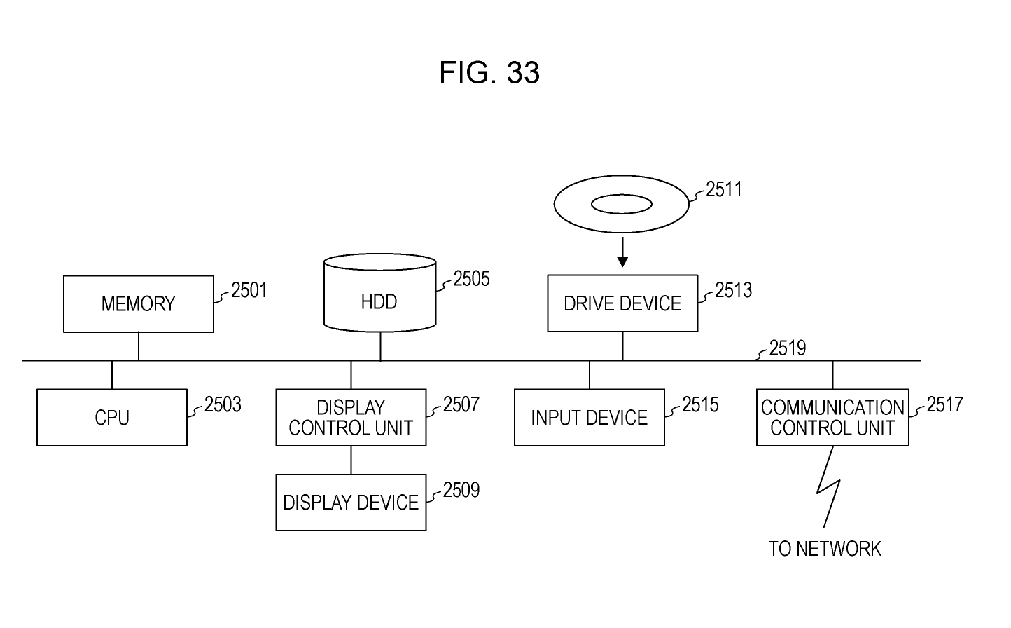

The flow comparison processing apparatus 100 described above is a computer apparatus, and is configured such that, as illustrated in FIG. 33, a memory 2501, a central processing unit (CPU) 2503, a hard disk drive (HDD) 2505, a display control unit 2507 connected to a display device 2509, a drive device 2513 for a removable disk 2511, an input device 2515, and a communication control unit 2517 to be connected to a network are connected to one another via a bus 2519. An operating system (OS) and an application program for performing the processes in the present embodiment are stored in the HDD 2505, and are read from the HDD 2505 into the memory 2501 when executed by the CPU 2503. The CPU 2503 controls the display control unit 2507, the communication control unit 2517, and the drive device 2513 to perform operations. Data obtained during processes is stored in the memory 2501, and is stored in the HDD 2505 if desired. In an embodiment of the present technique, an application program for performing the processes described above is stored and distributed in the removable disk 2511 which may be computer-readable, and is installed from the drive device 2513 into the HDD 2505. The application program may also be installed into the HDD 2505 via a network such as the Internet and the communication control unit 2517. Such a computer apparatus may implement the various functions described above through organic cooperation between the hardware described above such as the CPU 2503 and the memory 2501, the OS, and application programs.

According to the present embodiment, therefore, for example, based on a criterion in which most frequent occurrence groups of event categories in first flow data and occurrence position sections of nodes in second flow data are the same, it may be easily determined which event category and which node correspond to each other. Note that the second flow data may be implemented using an engineering drawing, or may be specified from a plurality of process instances in a manner similar to that in the first flow data. Further, the data to be stored in the second flow data storage unit may be automatically generated, or data manually created in advance may be stored in the second flow data storage unit. Furthermore, groups and position sections may be the same.

Furthermore, the statistical process as described above allows the specification of an occurrence position section and a more frequent occurrence group while reducing the influence of an exceptional process instance having a low frequency of occurrence. Moreover, since an occurrence position of each of events included in a process instance is determined based on the number of occurrences of the event in the process instance, the occurrence position may be normalized and specified in the process instance. Thus, even if the granularity of nodes is different from that of the comparison target flow, the flows may be compared under the same criterion of occurrence position in the overall flows.

Furthermore, since a plurality of nodes and the connection relationship between the nodes may be automatically specified, the occurrence position sections for the individual nodes may be automatically specified using the process described above.

Furthermore, event categories belonging to each group are presented, and nodes belonging to each occurrence position section are presented. This allows a user to easily specify the correspondence relationship therebetween.

In addition, the similarities between the names of event categories and the names of nodes in corresponding sections are calculated. Therefore, the correspondence relationship may be specified with high accuracy and may be presented to a user.

Furthermore, for example, the validity of a correspondence relationship specified by a user based on some external data may be determined in terms of the relationship between most frequent occurrence groups and occurrence position sections specified in the process described above.

In addition, the second flow data may also be specified from a set of process instances. In this case, the first flow data and the second flow data may be compared without any difficulties.

A program for allowing a communication device to perform the processes described above may be created, and the program is stored in a computer-readable storage medium or storage device such as, for example, a flexible disk, a compact disk read only memory (CD-ROM), a magneto-optical disk, a semiconductor memory, or a hard disk. Data obtained during processes is temporarily saved in a storage device such as a computer memory.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A flow comparison processing method executed by a computer, the method comprising:
determining, for each of a plurality of process instances each of which has a plurality of events arranged in a time series and which are stored in a first flow data storage unit configured to store data of the plurality of process instances as first flow data, an occurrence position of each of the events included in the process instance based on a number of occurrences of the event in the process instance, and storing the determined occurrence positions in a first data storage unit in association with the events;
extracting data of the events on an event-category-by-event-category basis from the first data storage unit, determining in which of a predetermined plurality of position sections the occurrence position of each of the events belonging to an event category is included, specifying, for each event category, a most frequent occurrence position section regarding the event category, and storing a most frequent occurrence group including the most frequent occurrence position section among a predetermined plurality of groups and the event category in a second data storage unit so that the most frequent occurrence group and the event category are associated with each other; and
displaying nodes included in second flow data which is different from the first flow data and which is compared with the first flow data and occurrence position sections of the nodes in association with each other, the nodes and the occurrence position sections being stored in a second flow data storage unit, the second flow data storage unit being configured to store the nodes included in the second flow data and the occurrence position sections of the nodes among a plurality of occurrence position sections, a number of which equals a number of the plurality of groups, so that the nodes and the occurrence position sections of the nodes are associated with each other, and displaying the event categories and the most frequent occurrence groups stored in the second data storage unit so that the event categories and the most frequent occurrence groups are associated with each other.

2. The flow comparison processing method according to claim 1, wherein
the second flow data is represented by a plurality of nodes including a start point and an end point, and a connection relationship between the nodes, and
the flow comparison processing method further comprises
calculating, based on data of the plurality of nodes regarding the second flow data stored in the second flow data storage unit and the connection relationship between the nodes, a shortest distance of each of the nodes, except for the start point and the end point, from the start point, and a shortest distance of each of the nodes, except for the start point and the end point, from the end point, and storing the calculated distances in a distance data storage unit, and
calculating a difference for each of the nodes between the shortest distance from the end point and the shortest distance from the start point stored in the distance data storage unit, specifying the occurrence position section for each of the nodes according to a predetermined threshold value, and storing the occurrence position sections in the second flow data storage unit.

3. The flow comparison processing method according to claim 1, wherein
the displaying includes listing, for each of the groups, the event categories each associated with the group as the most frequent occurrence group in the first flow data, and listing, for each of the occurrence position sections, the nodes associated with the occurrence position section in the second flow data, and
the flow comparison processing method further comprises receiving an input for associating the event categories in the first flow data with the nodes in the second flow data, and storing the input as correspondence data in a correspondence data storage unit.

4. The flow comparison processing method according to claim 1, wherein the displaying includes calculating, for each of the groups for the first flow data, a similarity between a name of the event category associated with the group as the most frequent occurrence group, and a name of a node associated with an occurrence position section corresponding to the group in the second flow data, and displaying the name of the event category and the name of the node having the highest similarity so that the name of the event category and the name of the node are associated with each other.

5. The flow comparison processing method according to claim 1, wherein the displaying includes
receiving an input for associating the event categories in the first flow data with the nodes in the second flow data, and storing the correspondence data between the associated event categories and nodes in the correspondence data storage unit, and
displaying, together with the correspondence data stored in the correspondence data storage unit, the most frequent occurrence groups stored in the second data storage unit in association with the event categories and the occurrence position sections stored in the second flow data storage unit in association with the nodes in such a manner that the most frequent occurrence groups and the occurrence position sections are compared with each other.

6. The flow comparison processing method according to claim 1, wherein
the second flow data storage unit is configured to store, as second flow data, data of a plurality of process instances of a second type each having a plurality of events arranged in a time series, and
the flow comparison processing method further comprises:
determining, for each of the process instances of the second type stored in the second flow data storage unit, an occurrence position of each of the events included in the process instance of the second type based on the number of occurrences of the event in the process instance of the second type, and storing the determined occurrence positions in the second flow data storage unit in association with the events, and
extracting data of events for each of the event categories from the second flow data storage unit, determining in which of the plurality of position sections the occurrence position of each of the events belonging to the event category is included, specifying, for each of the event categories, a most frequent occurrence position section regarding the event category, and storing a group including the most frequent occurrence position section among the plurality of groups as an occurrence position section for the second flow data and the event category as a node for the second flow data in the second flow data storage unit.

7. A recording medium recording a flow comparison processing program to be executed to perform a process comprising:
determining, for each of a plurality of process instances each of which has a plurality of events arranged in a time series and which are stored in a first flow data storage unit configured to store data of the plurality of process instances as first flow data, an occurrence position of each of the events included in the process instance based on a number of occurrences of the event in the process instance, and storing the determined occurrence positions in a first data storage unit in association with the events;
extracting data of the events on an event-category-by-event-category basis from the first data storage unit, determining in which of a plurality of predetermined position sections the occurrence position of each of the events belonging to the event category is included, specifying, for each event category, a most frequent occurrence position section regarding the event category, and storing a most frequent occurrence group including the most frequent occurrence position section among a plurality of predetermined groups and the event category in a second data storage unit so that the most frequent occurrence group and the event category are associated with each other; and
displaying nodes included in second flow data which is different from the first flow data and which is compared with the first flow data and occurrence position sections of the nodes in association with each other, the nodes and the occurrence position sections being stored in a second flow data storage unit, the second flow data storage unit being configured to store the nodes included in the second flow data and the occurrence position sections of the nodes among a plurality of occurrence position sections, a number of which equals a number of the plurality of groups, so that the nodes and the occurrence position sections of the nodes are associated with each other, and displaying the event categories and most frequent occurrence groups stored in the second data storage unit so that the event categories and the most frequent occurrence groups are associated with each other.

8. A flow comparison processing apparatus comprising:
a first flow data storage unit configured to store, as first flow data, data of a plurality of process instances each having a plurality of events arranged in a time series;
a determining unit which determines, for each of the process instances stored in the first flow data storage unit, an occurrence position of each of the events included in the process instance based on a number of occurrences of the event in the process instance, and stores the determined occurrence positions in a first data storage unit in association with the events;
an extracting unit which extracts data of the events on an event-category-by-event-category basis from the first data storage unit, determines in which of a plurality of predetermined position sections the occurrence position of each of the events belonging to the event category is included, specifies, for each event category, a most frequent occurrence position section regarding the event category, and stores a most frequent occurrence group including the most frequent occurrence position section among a plurality of predetermined groups and the event category in a second data storage unit so that the most frequent occurrence group and the event category are associated with each other; and
a display unit which displays nodes included in second flow data which is different from the first flow data and which is compared with the first flow data and occurrence position sections of the nodes in association with each other, the nodes and the occurrence position sections being stored in a second flow data storage unit, the second flow data storage unit being configured to store the nodes included in the second flow data and the occurrence position sections of the nodes among a plurality of occurrence position sections a number of which equals a number of the plurality of groups so that the nodes and the occurrence position sections of the nodes are associated with each other, and displays the event categories and most frequent occurrence groups stored in the second data storage unit so that the event categories and the most frequent occurrence groups are associated with each other.
